(19) United States
(12) Patent Application Publication
(10) Pub. No.: US 2026/0247171 A1
(43) Pub. Date: Aug. 20, 2026

(54) LOGICAL CHANNEL FOR AN AI/ML PLANE

(71) Applicant: AT&T Intellectual Property I, L.P., Atlanta, GA (US)

(72) Inventors: Jyotirmoy Banik, Round Rock, TX (US); Milap Majmundar, Austin, TX (US); Salam Akoum, Austin, TX (US); Isfar Tariq, Austin, TX (US)

(73) Assignee: AT&T Intellectual Property I, L.P., Atlanta, GA (US)

(21) Appl. No.: 19/054,199

(22) Filed: Feb. 14, 2025

Related U.S. Application Data
(60) Provisional application No. 63/747,711, filed on Jan. 21, 2025.

(51) Int. Cl. H04W 24/02; H04W 72/20

(52) U.S. Cl. CPC H04W 24/02; H04W 72/20

(57) ABSTRACT

Aspects of the subject disclosure may include, for example, implementing a control plane and a user plane for managing operation of a mobile communication network; and implementing, by the processing system, an artificial intelligence/machine learning plane (AMP) within the communication network that utilizes a logical channel for carrying AI/ML-related data, wherein the logical channel is mapped to a transport channel and a physical channel. Various configuration parameters can be utilized and provisioned for features of the AMP including the logical channel or the AI/ML Radio Bearer (AMRB). Other embodiments are disclosed.

### CROSS REFERENCE TO RELATED APPLICATIONS

The present application claims the benefit of priority to U.S. Provisional Application No. 63/747,711 filed Jan. 21, 2025. All sections of the aforementioned application are incorporated herein by reference in their entirety.

One or more of the embodiments described herein can be combined in whole or in part with the embodiments described in co-pending U.S. Patent Applications (1) Serial No. ___ (having Attorney Docket No. 2024-2281_7785-3822A), filed on ___; (2) Serial No. ___ (having Attorney Docket No. 2024-2282_7785-3823A), filed on ___; (3) Serial No. (___ (having Attorney Docket No. 2024-2284_7785-3824A), filed on ___; (4) Serial No. ___ (having Attorney Docket No. 2024-2283_7785-3826A), filed on ___; (5) Serial No. ___ (having Attorney Docket No. 2024-2285_7785-3827A), filed on ___; and (6) Serial No. ___ (having Attorney Docket No. 2024-2286_7785-3828A), filed on ___, the disclosures of all of which are hereby incorporated by reference herein in their entirety. For instance, embodiments of one or more of the aforementioned U.S. application(s) can be combined in whole or in part with embodiments of the subject disclosure. For example, one or more features and/or embodiments described in one or more of the aforementioned U.S. application(s) (including components, functions, data types, and/or configurations) can be used in conjunction with (or as a substitute for) one or more features and/or embodiments described herein (including components, functions, data types, and/or configurations), and vice versa.

### FIELD OF THE DISCLOSURE

The subject disclosure relates to a logical channel for an artificial intelligence/machine learning (AI/ML) plane.

### BACKGROUND

Current generation mobility networks have separated a control plane from a user plane, and deploy the control plane and the user plane independently. This has allowed for improved resource allocation and network performance. Increased use of AI/ML in such networks has the potential to utilize and process large amounts of data in the network. AI/ML based solutions are implementation-based and generally do not involve signaling or an input from the network, and thus have not been part of the cellular network standardization.

In the rapidly evolving landscape of cellular networks, the integration of AI/ML technologies has become increasingly important for optimizing network performance. As cellular networks transition from 5G to 6G and beyond, the complexity of managing diverse configurations and system parameters has and will grow significantly. This complexity is compounded by the heterogeneous nature of modern networks, which include a variety of frequency bands, macro and small cell deployments, and diverse service offerings. Traditional network optimization methods struggle to adapt to these dynamic environments, often failing to provide a desired differentiation and prioritization for AI/ML traffic. This lack of differentiation can lead to inefficiencies, as AI/ML traffic is often grouped with either control plane traffic, which lacks sufficient bandwidth, or user plane traffic, which is not designed to handle such data.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 2C is a block diagram illustrating an example, non-limiting embodiment of channel mapping for a network for uplink and downlink communications such as functioning within the communication networks of FIGS. 1 and 2A in accordance with various aspects described herein.

FIGS. 2D-2F depict illustrative embodiments of methods in accordance with various aspects described herein.

FIG. 2G depicts an illustrative embodiment of a configuration table for configuration parameters or other information that can be utilized for the logical channel in accordance with various aspects described herein.

FIG. 2H depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for an artificial intelligence/machine learning plane (AMP) within a communications network, which can operate in parallel with the control and user planes to manage AI/ML data traffic efficiently. A logical channel for the AMP can be established or otherwise utilized for the AI/ML data traffic, such as in a mobile communication network.

One or more embodiments provide a new logical channel specifically designed for, or otherwise useable with, the AMP within a communication network. This logical channel, termed the AI/ML Control Channel (AMCCH), can be distinct in its ability to carry AI/ML-related traffic (including in some embodiments only AI/ML-related traffic), thereby separating (in whole or in part) this traffic from traditional control and/or user plane traffic. This separation can allow for differential treatment of AI/ML data, optimizing or otherwise improving network operations by enabling a Media Access Control (MAC) layer to prioritize or otherwise differentiate handling of AI/ML traffic based on the specific requirements of that data.

In one or more embodiments, the system and functionality described herein provides mapping of the logical channel to specific transport and/or physical channels, such as Downlink Shared Channel (DL-SCH) and Physical Downlink Shared Channel (PDSCH) for downlink, and Uplink Shared Channel (UL-SCH) and Physical Uplink Shared Channel (PUSCH) for uplink, ensuring efficient data transmission. In one or more embodiments, the system and functionality described herein provides that the AMCCH can be mapped to an AI/ML Radio Bearer (AMRB), facilitating an end-to-end path for AI/ML traffic across the Radio Access Network (RAN) and the broader Network (CN). This approach not only enhances the network's ability to handle AI/ML data but also aligns with future network architectures, such as 6G or next generation, by providing a scalable and flexible framework for AI/ML integration.

In one or more embodiments, the AMRB can be a dedicated radio bearer or can be a non-dedicated radio bearer. In one or more embodiments, the transport channel(s) can be a dedicated and/or non-dedicated transport channel(s), which can include use of both dedicated and non-dedicated transport channels. In one or more embodiments, the physical channel(s) can be a dedicated and/or non-dedicated physical channel(s), which can include use of both dedicated and non-dedicated physical channels. In these examples, dedicated can include dedicated to a single (or group of) user(s)/device(s), dedicated to a single (or group of) service(s), or some other type of dedication criterion.

In one or more embodiments, mapping between the AMCCH, the transport channel(s), and the physical channel(s) can be facilitated through signaling procedures and configurations communicated amongst devices, including the base stations and UEs. As an example, Radio Resource Control (RRC) signaling messages can be utilized, which provide the necessary configuration parameters for the logical, transport, and physical channels. For instance, the RRC signaling can specify how the AMCCH is mapped to the transport channels, such as the DL-SCH and UL-SCH, and further to the physical channels, like the PDSCH and PUSCH. These messages ensure that both the base stations and UEs are aware of the channel mappings, allowing them to handle AI/ML traffic efficiently and prioritize it according to its specific Quality of Service (QoS) requirements. By using these signaling procedures, the network can dynamically manage and adapt the channel mappings based on current (and/or predicted) network conditions and traffic demands, ensuring optimal performance and resource utilization for AI/ML data transmission. In one or more embodiments, the AI/ML-related data can be various types of AI/ML-related data, which can be defined in various ways (and/or defined by various entities including service providers, Standards bodies and so forth), such as data or other information for internal use by the service provider in conjunction with AI/ML models.

One or more aspects of the subject disclosure is a method including implementing, by a processing system including a processor, a control plane and a user plane for managing operation of a communication network; implementing, by the processing system, an artificial intelligence/machine learning plane (AMP) within the communication network, wherein the AMP operates independently of and in parallel with the control plane and the user plane; and providing, by the processing system for use by the AMP, a logical channel for carrying AI/ML-related data within the communication network.

One or more aspects of the subject disclosure are a device comprising a processing system including a processor; and a memory that stores executable instructions that, when executed by the processing system, facilitate performance of operations. The operations can include communicating control data in a communication network according to a control plane architecture; communicating user data in the communication network according to a user plane architecture; and communicating artificial intelligence/machine learning (AI/ML) data in the communication network according to an artificial intelligence/machine learning plane (AMP) architecture that utilizes a logical channel for carrying AI/ML-related data, where the logical channel is mapped to a transport channel and a physical channel.

One or more aspects of the subject disclosure include a non-transitory machine-readable medium, comprising executable instructions that, when executed by a processing system including a processor, facilitate performance of operations. The operations can include implementing a control plane and a user plane for managing operation of a communication network; and implementing an artificial intelligence/machine learning plane (AMP) within the communication network that utilizes a logical channel for carrying AI/ML-related data, where the logical channel is mapped to a transport channel and a physical channel.

In one or more embodiments, the logical channel (e.g., AMCCH) can be exclusively (or non-exclusively) mapped to the AI/ML Radio Bearer (AMRB) to carry the AI/ML related traffic across the RAN. In one or more embodiments, the AMCCH can be divided/categorized into two categories based on the direction of the traffic: DL-AMCCH and UL-AMCCH. In this example, both logical channels (or both categories of the AMCCH) can support different message types. In one embodiment, the AMCCH creates a logical distinction for AI/ML related traffic and does not mix it with other types of traffic (control and user), which allows the MAC layer to multiplex and demultiplex according to the priority of the AI/ML traffic, and which creates an end-to-end path for the AI/ML related traffic across the RAN and Core Network. Messages on the AMCCH can be constructed in various ways, including following formatting and policies described in the 3GPP or according to other guidelines or rules.

One or more embodiments of the system and methodology provide features and functionality (e.g., messaging) that allow the RRC layer to configure and support the logical channel (e.g., AMCCH) and to configure and support a radio bearer (e.g., AMRB) as described herein.

One or more embodiments of the system and methodology support the AMRB utilizing new or modified elements, which can include a method or process to add bearers to a list of existing AMRB bearers. For example, this method of addition or modification can include establishing a Packet Data Convergence Protocol (PDCP) entity and configuring it, such as for each AMRB identity; configuring security for the AMRB; and establishing an AI/ML Application Protocol (AMAP) entity. As an example, messaging can be provided that facilitates this process, such as an AMRB-ToAddModList information element or message which can be communicated or exchanged to/from/between devices including a UE, a base station or other communication devices.

One or more embodiments of the system and methodology provide features and functionality (e.g., messaging) that allow for releasing bearers from the list of existing bearers. This can include releasing a PDCP entity and an AMRB identity; and indicating the AMRB release to the AMAP and upper layers of the network. Various messaging can be utilized such as an AMRB-ToReleaseList which can be a sequence of SIZE (1..maxAMRB)) of AMRB-Identity, which is used to release the AMRB.

In one embodiment, the AMRB configuration in the RRC configuration allows the RRC to setup an AMRB bearer properly which is required to support the AMP data transfer. In one embodiment, the AMCCH configuration in the RRC configuration allows the RRC to setup the AMCCH logical channels properly. Setting up the AMCCH allows the DL scheduler to provide differential treatment to AI/ML data, which flows across the AMP, and thus improves AI/ML model performance. One or more embodiments of the system and methodology provide features and functionality (e.g., messaging) that allows the MAC layer to consider the AMCCH while multiplexing logical channels, especially during the process of Logical Channel Prioritization, whereby in one or more embodiments logical channel prioritization is applicable to the uplink only. This in turn allows the AI/ML traffic to be differentiated in the UL. One or more embodiments of the system and methodology provide features and functionality (e.g., messaging) that allows the AMAP layer to connect to the lower layers of the protocol stack through the RRC configuration.

One or more aspects of the subject disclosure are a method including establishing, by a processing system including a processor, a Packet Data Convergence Protocol (PDCP) entity for an AI/ML radio bearer (AMRB) of a communication network to manage transmission of AI/ML-related data, where the communication network includes a control plane, a user plane, and an artificial intelligence/machine learning plane (AMP), where the AMP operates independently of and in parallel with the control plane and the user plane, and where the AMP utilizes a logical channel for carrying the AI/ML-related data within the communication network; configuring, by the processing system, a security for the AMRB; and establishing, by the processing system, an AI/ML Application Protocol (AMAP) entity to interface between the AMP and other layers of the communication network.

One or more aspects of the subject disclosure are a device including a processing system including a processor; and a memory that stores executable instructions that, when executed by the processing system, facilitate performance of operations. The operations can include transmitting, by a base station of a communication network to a communication device, a message that includes configuration parameters for a logical channel for carrying AI/ML-related data within the communication network, the communication network including a control plane, a user plane, and an artificial intelligence/machine learning plane (AMP), where the AMP operates independently of and in parallel with the control plane and the user plane; and receiving, by the base station from the communication device, AI/ML-related data via the logical channel.

One or more aspects of the subject disclosure are a non-transitory machine-readable medium, comprising executable instructions that, when executed by a processing system including a processor, facilitate performance of operations. The operations include transmitting, by a base station of a communication network to a communication device, a message, wherein the message indicates one or more AI/ML Radio Bearers (AMRBs) to be added or modified and configuration parameters for the AMRBs, where the communication network including a control plane, a user plane, and an artificial intelligence/machine learning plane (AMP), where the AMP operates independently of and in parallel with the control plane and the user plane, and where a logical channel of the AMP is configured carrying AI/ML-related data within the communication network; and receiving, by the base station from the communication device, AI/ML-related data via the logical channel.

In one or more embodiments, the AMP facilitates data collection, model transfer, and lifecycle management of AI/ML models across various network entities, ensuring inter-vendor collaboration and enhanced network performance. By dynamically allocating resources and providing full visibility and control over AI/ML data, the AMP optimizes network operations while maintaining data privacy and security. Other embodiments are described in the subject disclosure.

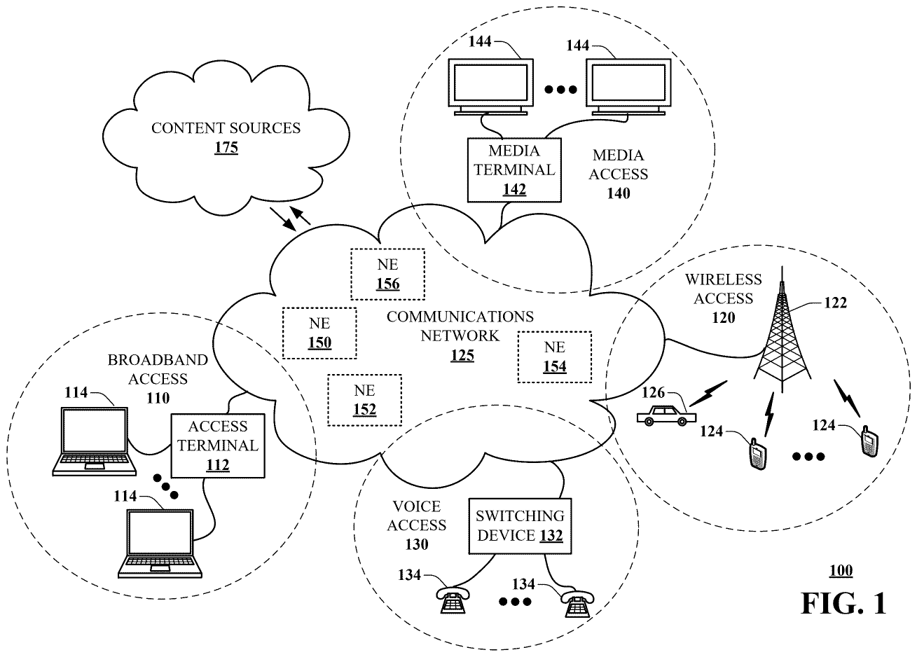

Referring now to FIG. 1, a block diagram is shown illustrating an example, non-limiting embodiment of a system 100 in accordance with various aspects described herein. For example, system 100 can facilitate in whole or in part implementing a control plane and a user plane for managing operation of a mobile communication network and implementing an artificial intelligence/machine learning plane (AMP) within the mobile communications network, wherein the AMP operates independently of and in parallel with the control plane and the user plane. System 100 can further facilitate in whole or in part implementing a control plane and a user plane for managing operation of a mobile communication network; and implementing, by the processing system, an artificial intelligence/machine learning plane within the communication network that utilizes a logical channel for carrying AI/ML-related data, where the logical channel is mapped to a transport channel and a physical channel. Various configuration parameters can be utilized and provisioned for features of the AMP including the logical channel or the AI/ML Radio Bearer (AMRB).

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

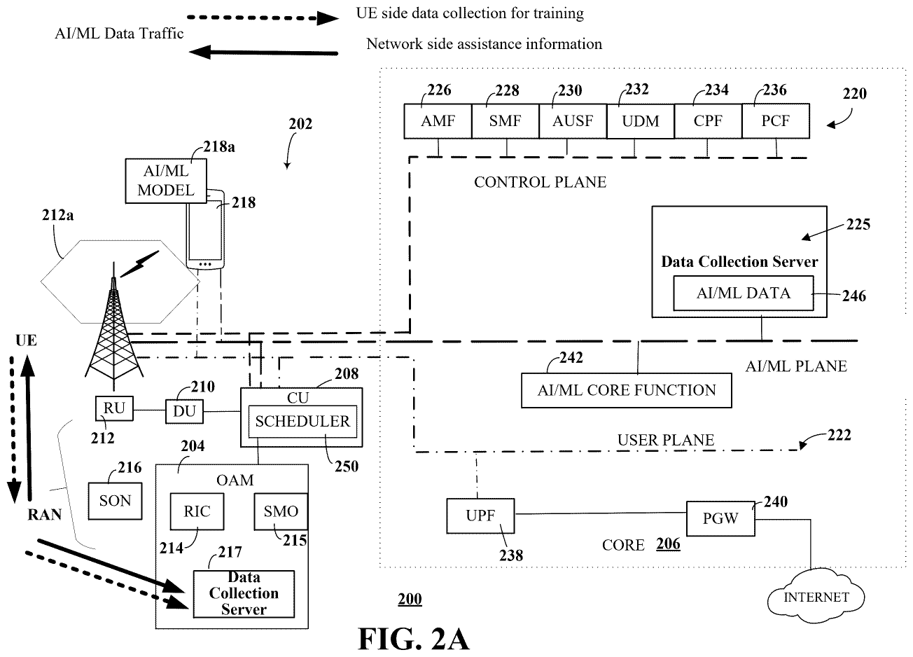

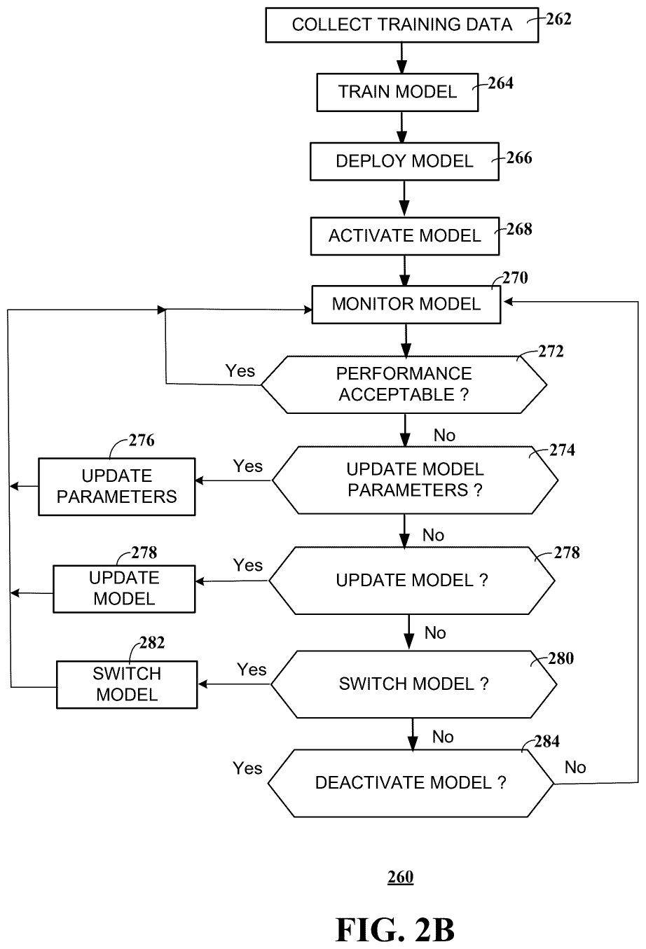

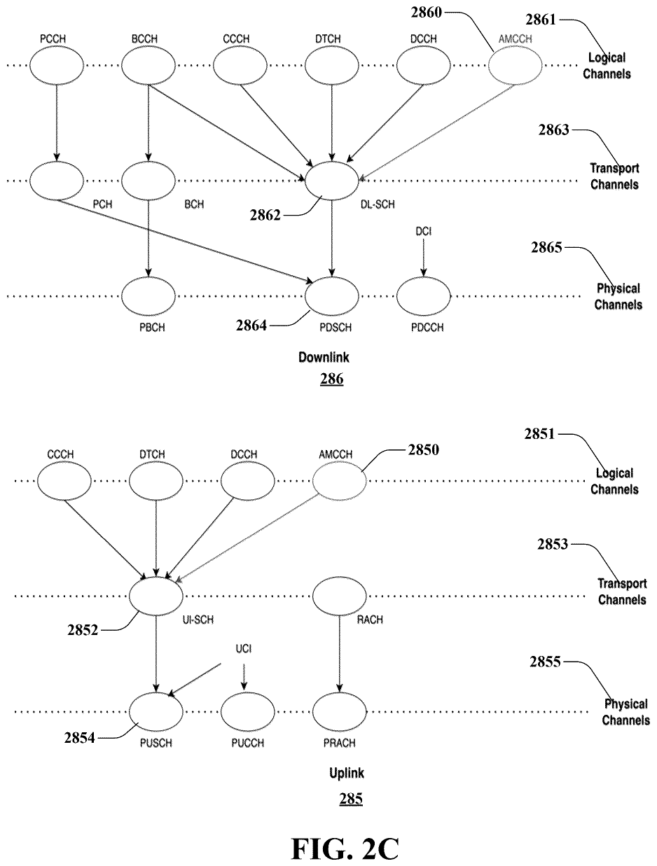

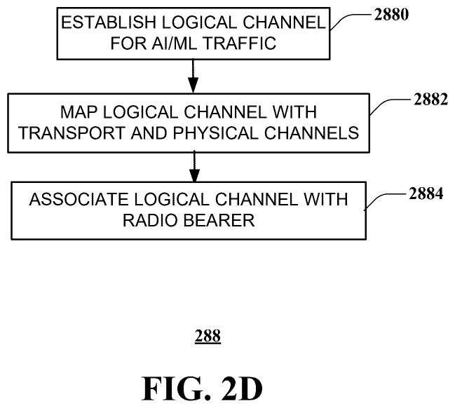

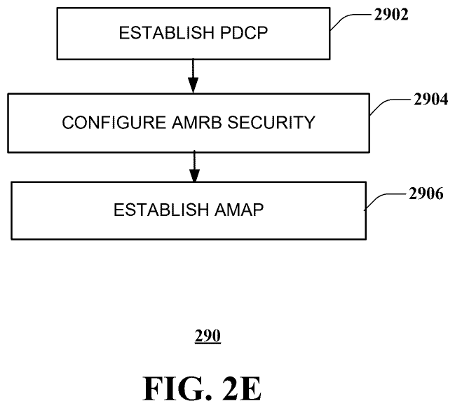

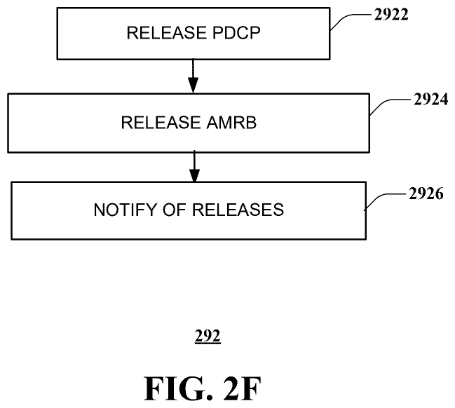

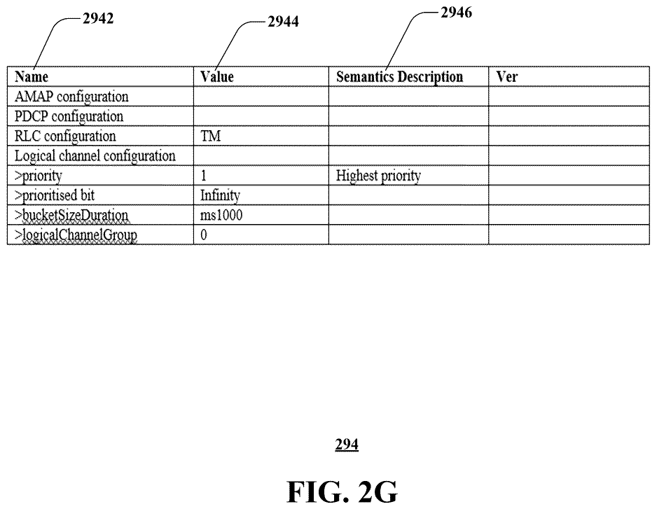

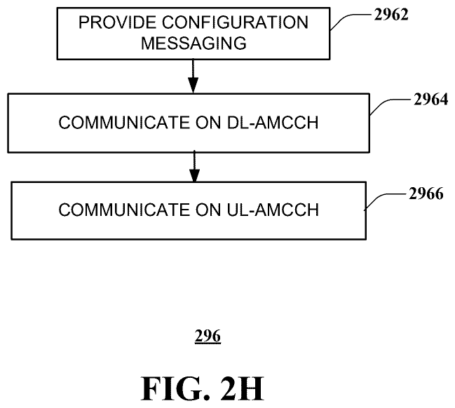

FIG. 2A is a block diagram illustrating an example, non-limiting embodiment of a system functioning within the communication network of FIG. 1 in accordance with various aspects described herein. The system 200 includes a cellular network 202. In embodiments, the cellular network 202 may be owned and operated by a mobile network operator (MNO), also referred to as a cellular service provider (CSP).

The cellular network 202 in the exemplary embodiment includes a core network 206, one or more centralized units such as centralized unit (CU) 208, one or more distributed units such as distributed unit (DU) 210, one or more radio units (RU) 212, an operations, administration and maintenance function 204 including a radio access network (RAN) intelligent controller (RIC) 214, a service management and orchestration (SMO) function 215 and a self-organizing network (SON) 216. Other embodiments of cellular networks will have additional or alternative components.

The core network 206 provides a variety of centralized functions for the cellular network 202. Such functions may include mobility management, accounting and authorization and others. Further, the core network 206 may include one or more gateways to other networks such as the public internet.

The CU 208 serves as a logical node within the ORAN architecture of cellular networks. The CU 208 hosts key protocol layers, including the Radio Resource Control (RRC), Service Data Adaptation Protocol (SDAP), and Packet Data Convergence Protocol (PDCP). The RRC layer is responsible for managing the connection between the user equipment (UE) and the network, handling tasks such as mobility management and connection setup. The SDAP layer maps Quality of Service (QoS) flows to data radio bearers, ensuring that data is transmitted with the appropriate QoS parameters. The PDCP layer provides header compression, encryption, and integrity protection, facilitating secure and efficient data transfer. The CU 208 communicates with the core network 206 and distributed units such as DU 210 to exchange information to manage radio resources and user sessions.

The DU 210 is a logical node within the ORAN architecture of cellular networks, responsible for hosting the Radio Link Control (RLC), Medium Access Control (MAC), and high Physical (PHY) protocol layers. The RLC layer provides error correction and data segmentation, ensuring reliable data transmission. The MAC layer manages resource allocation and scheduling, optimizing the use of available radio resources. The high PHY layer deals with the transmission and reception of data over the air interface, handling tasks such as modulation and coding. improved support for high-bandwidth applications. The DU 210 manages radio resources such as the RU 212. The DU 210 operates as a baseband unit (BBU) to process baseband communication signals between the RU 212 and the CU 208, including both uplink (UL) and downlink (DL) signals. The uplink is the radio connection from the UE 218 to the RU 212; the downlink is the radio connection from the RU 212 to the UE 218. The DU 210 in combination with one or more RUs such as RU 212 establishes a radio access network (RAN) for access by a subscriber unit or user equipment (UE) such as UE 218. The RU 212 provides communications services to a coverage area 212a near the RU 212 for UEs such as the UE 218 in the coverage area 212a.

The RU 212 is in radio communication with radio devices such as UE 218, other user equipment, internet of things (IoT) devices, and others. The RU 212 may include or be part of an eNodeB in a fourth generation (4G, or long-term evolution, LTE) cellular network or a gNodeB in a 5G, 6G, or later cellular network. The RU 212 operates according to an air interface standard such the standards published by the 3^{rd} Generation Partnership Project (3GPP; 3GPP is a registered trademark of the European Telecommunication Standards Institute). User devices such as UE 218 may attach to the cellular network 202 by initiating communication with the RU 212. The RU 212 and similar RUs provide user mobility by handing off radio communications with the UE 218 from the RU 212 to another RU in the cellular network.

The RIC 214 manages and optimizes various function for the RAN. The RIC 214 may be divided into real-time and near-real-time functions. The non-real-time RIC is part of the CSP's service management and orchestration (SMO) function 215. The SMO function 215 enables automation and orchestration, resource management and service management, network monitoring and analytics in the RAN. In this role, the non-real-time RIC enables control of RAN elements and their resources.

The SON 216 cooperates with other components of the cellular network 202 to improve network performance. In one example, the SON 216 operates to adjust radio frequencies used by different network elements to minimize interference, improve coverage and network capacity. In some embodiments, the SON 216 implements artificial intelligence (AI) or machine learning (ML) processes to manage network operation based on collected data about the network and network operation.

The UE 218 may be any mobile or portable radio device or IoT device capable of communicating with the cellular network. In general, the UE communicates on one or more frequency bands and operates under control of the cellular network. The cellular network 202 may be a fifth generation (5G) cellular network or later modification or enhancement, such as a sixth generation (6G) cellular network. The UE 218 may communicate with the 5G, 6G and other network technologies.

The core network 206 serves as the backbone of the cellular network 202. The core network 206 enables delivery of services and applications in the network. The core network architecture comprises various network functions and elements, each serving specific roles in facilitating communication between users, devices, and applications. In accordance with embodiments described herein, the core network 206 includes a control plane (CP) 220, a user plane (UP) 222 and an artificial intelligence/machine learning plane (AMP) 224.

The control plane 220 is responsible for signaling and control functions to establish, maintain, and terminate communication sessions. The control plane 220 is responsible for session management, mobility management, authentication, and security, as well as resource allocation, which includes allocating network resources and managing network slices. The CP 220 deals with control messages which are typically small in size but critical for network operations. The CP 220 also usually requires low latency for rapid signaling responses to ensure efficient session management and mobility. The CP 220 utilizes signaling protocols such as RRC (radio resource control) and NAS (Non-Access Stratum).

As illustrated in FIG. 2A, the CP 220 may include a number of functions that cooperate to provide the CP functionality. In the illustrated example embodiment, an access and mobility function (AMF) 226 manages user registration, mobility and resource allocation. A Session Management Function (SMF) 228 controls data sessions and quality of service (QoS) parameters. An Authentication Server Function (AUSF) 230 handles user authentication and authorization. A Unified Data Management (UDM) function 232 stores user data and subscriptions. A Control Plane Function (CPF 234 manages signaling and control functions within the cellular network, including mobility management, session management and authentication. A Policy Control Function (PCF) 236 is responsible for enforcing network policies and service level agreements (SLAs) within the cellular network 202. The PCF 236 dynamically allocates resources, applies QoS rules, and enforces traffic management policies based on user profiles, service requirements, and network conditions. Other embodiments of a control plane may include additional or alternative functional aspects and some of the illustrated functional aspects may be combined together.

The user plane (UP) 222 deals with the actual data transfer between a user device such as UE 218 and the cellular network 202. The UP 222 is responsible for data transmission, and quality of service (QoS) management. QoS management includes ensuring quality of service by prioritizing different types of traffic to meet performance requirements. The UP 222 transfers large volumes of user data, which can include high-definition video, voice and other types of content. Latency requirements for the UP 222 depend on the type of traffic or application. For example, low latency is generally required for gaming or video streaming applications operated on a UE such as UE 218. The UP 222 uses data transfer protocols such as packet data convergence protocol (PDCP), service data adaptation protocol (SDAP), GPRS Tunnelling protocol-user plane (GTP-U). The UP 222 involves the user plane function (UPF) 238 for data routing and forwarding. For example, the UPF 238 is responsible for forwarding user data packets between the device and the internet. The core network 206 includes a packet gateway (PGW) 240 to control data communications between the core network 206 and other networks including the public internet.

As noted, the UP 222 is responsible for management of quality of service (QoS). QoS management ensures that the various types of traffic receive the appropriate priority and resources to meet their specific performance requirements. QoS management includes standard-defined traffic classification and marking, traffic policing and shaping, resource allocation, scheduling and queue management. The relation between radio bearers and QoS flows is related to how the network manages and delivers different types of traffic with varying QoS requirements. QoS flows are the highest level of traffic categorization in 5G new radio (NR), representing a stream of packets that share the same QoS requirements. Each QoS flow is identified by a QoS Flow Identifier (QFI) and is characterized by specific QoS parameters such as latency, throughput, reliability, priority. Radio bearers are the channels over which data is transmitted between the UE and the network. They are categorized into data radio bearers (DRBs) used for carrying the data and signaling radio bearers (SRBs) used for carrying control plane signaling messages. Each QoS flow is mapped to one or more data radio bearers. This mapping is based on the QoS requirements of the flow. The network assigns appropriate radio bearers to carry the QoS flow data, ensuring that the QoS parameters such as latency, throughput, and reliability are met. The network configures the radio bearers with the necessary parameters to meet the QoS requirements of the QoS flows, including setting priority levels, scheduling policies and resource allocation. The network monitors and manages the radio bearers to adapt to changing network conditions and user demands. This may involve reconfiguring bearers, adjusting resource allocation, or even establishing new bearers to meet the QoS requirements.

5G and possibly 6G networks employ control plane and user plane separation (CUPS). This enables improved flexibility and scalability. The control plane and the user plane can be deployed independently, allowing for improved resource allocation and network performance. Further, CUPS enables creation of customized network slices with tailored QoS and security for different applications such as internet of things (IoT) and autonomous vehicles. Furthermore, CUPS enables edge computing in which network functions are deployed close to the edge of the network, reducing latency and improving performance for latency-sensitive applications.

One of the fundamental challenges for large scale cellular networks such as cellular network 202 is optimization of multiple configurations and to be able to adapt the system parameters to provide optimal performance for a given scenario. The performance of the system is typically measured through a set of key performance indicators (KPIs) such as system throughput, latency, user quality of experience (QoE), coverage, reliability and number of active user equipment devices (UEs) present in the system.

With each new generation of cellular technology, from 4G to 5G to 6G and beyond, optimizing cellular networks grows more complex as the number of configurations and system parameters increases due to availability of more features and use cases. Similarly, optimizing the system for KPIs including those examples listed above becomes more complex as different active UEs in the network have different QoE requirements, depending on the application the UEs are running. Furthermore, due to the network becoming more heterogenous in terms of frequency bands, frequency ranges, deployments of macro cells and small cells, diverse service offerings and traffic characteristics, and coexistence of different architectures including centralized virtual RAN functions and distributed nodes to support latency-sensitive edge computing and private networks, it is becoming increasingly difficult to develop simple rule-based algorithm to optimize the network.

In recent years, the availability of large amounts of data and cost effective compute power have led to increased usage of AI/ML models on the devices and on the network infrastructure to achieve better optimization compared to the legacy non-AI/ML models. Most of these AI/ML based solutions are implementation-based, for instance, optimizing and improving operations of applications, devices, chipsets, etc. and may not require signaling or inputs from cellular networks. Thus, the AI/ML based solutions have not been part of the cellular network standardization. An AI/ML model has the potential to utilize and process large amounts of data related to the optimization problem and generate an output that can provide near optimum performance for the given problem. In a cellular network, it had been quite difficult to get access to the actual network data and therefore for the past few years, implementation-based AI/ML models have been developed using synthetic data with no or limited feedback from the network, which results in limited performance improvement in real world deployments.

In general, an AI/ML model may be defined as a data driven algorithm by applying machine learning techniques that generates a set of desired outputs based on a set of inputs. In examples, an AI/ML model may be a deep neural network, a classical model such as regression, a support vector machine (SVM), decision trees, or any other data driven algorithm. Also in examples, AI/ML models may be one-sided or two sided. A one-sided model at the UE is an AI/ML model whose inference happens at the UE. A one-sided model at the network is AI/ML model whose inference happens at a network element of the cellular network. A two-sided model is a paired AI/ML model or models over which joint inference is performed, where joint inference comprises AI/ML inference whose inference is performed jointly across the UE and the network. In an example, the first part of inference is first performed by the UE and then the remaining part is performed by a network element such as a gNB, or vice versa.

Recently, standards development organizations started studying and specifying the benefits of augmenting the network with features to enable improved support of AI/ML based algorithms for enhanced performance and/or reduced complexity/overhead of the 5G system. The enhanced performance depends on the use cases, and could be related to improved throughput, robustness, accuracy, or reliability, etc. AI/ML in 5G however is not native, in the sense that the introduction of features, and corresponding signaling, related to AI/ML models at the UE side or the network side, is retrofitted to the existing 5G network and the 5G network architecture. This can make it hard to design a flexible AI/ML framework for all use cases. Enhancements to the existing 5G network have heretofore thus been limited.

AI/ML models used in cellular networks have a definite life cycle. The AI/ML life cycle involves various stages, from data collection, algorithm selection to model building, training, tuning, testing, deployment, management, monitoring, and inference. To be deployed in a cellular network, AI/ML models are first developed depending on the use case and where the model will reside.

Model training is one of the main steps of model development. AI/ML model training in general is a process to train an AI/ML model, by learning the input/output relationship, in a data-driven manner and obtain the trained AI/ML model for inference. To train even a simple AI/ML model requires collecting large amounts of historical data from one or multiple entities across the network. The training data is then transferred to a training server using a data collection framework.

After the model is developed, a similar framework to data collection is needed for model transfer/delivery to transfer and deploy the model to the entities responsible for inference using the AI/ML model. Delivery of an AI/ML model over the air interface may involve either parameters of a model structure known at the receiving end or a new model with parameters. Delivery of the model may contain a full model or a partial model. After model deployment, model activation enables the AI/ML model for a specific function. Further, model deactivation may disable the AI/ML model for a specific function.

Also, after deployment of the AI/ML model, model switching may involve deactivating a currently active AI/ML model and activating a different AI/ML model for a specific function. Further, a model update is a process of updating the model parameters and/or model structure of a model. Similarly, a model parameter update: Process of updating the model parameters of a model.

After the model is deployed, a framework for life cycle management (LCM) and monitoring is required for the network to be able to monitor the performance of the AI/ML model through different performance metrics and make appropriate decision related to activation/deactivation/switching/fallback etc. for the AI/ML model/functionality. Note that for 5G networks, due to the limitations on what can be enhanced in the current framework, the design approaches for data collection, data transfer/delivery and monitoring are not scalable as the number of AI/ML models and use cases increase.

Data collection involves collection of historical data related to the AI/ML use case to be collected, transferred (over the air interface) and then stored at a data collection server for training the AI/ML model. For some applications, data collection for AI/ML is still under development for 5G. For any data collection, the network will determine when the data can be collected and transferred. For the termination and storage of data collected from the users, there are several different options that are under discussion including a data collection server outside the network (through standard-defined signaling or an over-the-top approach), to a data collection server in network OAM processes or to a data collection server at core. In some cases, the Mobile Network Operator (MNO) will have full visibility of the data collected from the users. If the data is stored inside the data collection server at the network, it will be managed by the network.

Referring to FIG. 2A, a data collection server 217 is depicted to be located in the OAM 204. Then UE side data collection for training and network side assistance information are provided to the data collection server via a gNodeB (e.g., the CU 208). Additionally or alternatively, the data collection server 217 can be located in the core network 206. In other embodiments, a third-party server can be used as a data collection server. The data collection server 217 may be accessed by xApps and/or rApps hosted on the OAM 204 to obtain AI/ML data stored therein.

AI/ML data may refer to information generated, collected, and utilized by AI/ML models within a network. This AI/ML data encompasses training datasets, model parameters, and monitoring metrics necessary for the development, deployment, and lifecycle management of AI/ML models. AI/ML data collection traffic, on the other hand, involve transmission of AI/ML data collection across the network, including the transfer of training data from user equipment (UE) to data collection servers, the delivery of trained models to network entities, and the exchange of assistance information between network components. The AI/ML data traffic is managed by a dedicated AI/ML plane (AMP), which operates independently of the control and user planes, ensuring proper handling of AI/ML data. Mobile network providers may need to have visibility and control over when and how the AI/ML data is sent, as user data should not be affected or changed by the AI/ML data and network capacity for accommodating the AI/ML data should be managed or monitored. In one or more embodiments, the AMP can make use of various components and functionality, including some existing components or functionality as described in 3GPP. In one or more embodiments, the AMP can use dedicated and/or non-dedicated bearer paths and/or dedicated and/or non-dedicated channels (including logical, transport and/or physical channels for managing traffic as described herein, including AI/ML traffic. Various messaging between network element(s) and UE(s) can be exchanged to provision, configure or otherwise manage the AMP, including configuration messages for bearer paths and/or channels.

Native AI/ML is an important aspect of next generation cellular networks. Industry trends that enable network virtualization and deployment of low latency, high bandwidth services will also enable application of artificial intelligence (AI) tools such as machine learning (ML) algorithms to 6G networks in a scalable manner.

In native AI/ML use cases, the 6G network operates with cross-domain AI/ML models, running across UEs, the RAN and the core network, and across different layers of the protocol stack. Such native AI/ML use cases are expected to be present to optimize the performance across different entities within the network. Cross layer AI/ML models, where inputs from one or multiple layers are used to train a model, and the AI/ML model output can be used by one or multiple layers.

Network elements of the cellular network, as well as UEs and IoT devices that communicate with the cellular network, are designed and manufactured by different vendors. Inter vendor collaboration between the network vendor and different user equipment vendors or between different entities in the network designed by different vendors, is an important aspect that needs to be addressed to ensure that the designed AI/ML model can perform well and be supported across different vendors.

Similarly, the network operator must manage and control the different data collection aspects such as when to collect data, privacy, and security of data and how to store and share the collected data (with the relevant parties through an SLA). The native AI/ML framework should be flexible to allow for quick updates of AI/ML model and to enable new features based on the current requirements of the network. Finally, the native AI/ML framework should be flexible and scalable to allow for AI/ML use cases to be quickly developed and deployed with limited framework enhancements, and if possible, to also have backward compatibility with the 5G framework.

Current 5G standardization efforts have mainly focused on the existing 5G network architecture and only allow for limited enhancements to support AI/ML use cases. This results in a design which is not supportive of any native AI/ML. In current 5G implementations, the network or its operation will need new enhancements whenever there is a new AI/ML use case. The AI/ML traffic consists of all data related to the AI/ML activities in the network and is not generated or terminating at any end user application.

As noted, in the existing 5G architecture there are two different planes, CP 220 and UP 222 where CP 220 is responsible for signaling and control functions to establish, maintain, and terminate communication sessions between the user and the network, while the UP is responsible for all the user data traffic. As the CP 220 communicates only the control-related information to maintain and manage the communication link between the user and the network, the CP 220 by design has a limited amount of bandwidth and high latency requirements. Further, any data transfer on the CP 220 is not charged to the users. On the other hand, the UP 222 communicates all the data traffic requested by the user and user applications. The UP 222 therefore has a relatively high bandwidth, variable latency and QoS requirements (based on user application), and the users are charged for the data usage on the UP 222.

AI/ML models are typically trained by collecting a large, real-world dataset as training data. After training on the training dataset, the models are then transferred and deployed to the users on UE. The size of the training dataset can be in the range of 100k to 100M data samples, depending on various aspects such as use case, type of model, generalization aspects, etc. Similarly, the model size can vary from 10k to 100M parameter model depending on the use case, model type and other aspects. Due to the large amount of the data involved and needing to be communicated on the network, it is important that the network has full visibility and control over when the data is shared to avoid any network impact. Additionally, the users should not be charged for the AI/ML model training data or model transfer. Users should only be charged for user data.

Having a control plane-based solution may not perform adequately due to the large amount of data to be communicated. Moreover, a user plane solution will not give any visibility to the network and can impact on its performance. Currently in air interface standards, one of the options under consideration is a hybrid approach using both the control plane and the user plane for communication of AI/ML data. However, the proposed hybrid approach requires significant modifications to the air interface standard as well as coordination across multiple work groups of a standards body. Furthermore, the hybrid approach will also increase the signaling load on the CP due to reporting of when and what data is being shared. The increase in signaling load also makes such an approach not scalable with the number of use cases. In addition, it can be very difficult to optimize data collection for multiple use cases in case some of the input data is common among them.

Another issue with the existing framework is the limitation regarding the AI/ML model life cycle management (LCM) operations and monitoring metrics that can be done on the control plane. Due to the limited bandwidth of the control plane, only short monitoring metrics can be reported to the user. Furthermore, using the control plane for AI/ML model LCM is also not very scalable in case of frequent configuration or functionality activation, deactivation, switching and fallback as the load on the control plane will increase with number of use cases.

In addition, in the current framework, each use case separately requires enhancements to the current interfaces to support the AI/ML data transfer. Such an approach is not scalable as for every new use case, the issue of how to transfer AI/ML-related data across different termination points must be revisited. Furthermore, such an approach makes it difficult to design a native architecture, as it is exceedingly difficult to get performance metrics for models at different layers and design them in a manner such that they do not impact performance of each other.

In general, three different approaches can be used to design for the native AI/ML in 6G. The first involves a hybrid of the control plane function and user plane function, based on the current framework. Second, the existing control plane can be overhauled and redesigned. Third, a new plane may be adopted and designated the AI/ML plane (AMP), to operate in parallel with the current CP and UP.

The first option can reuse the current 5G framework, but it is not well suited for native AI/ML and would require significant work in order to fix several core issues with the 5G framework. However, there will still be the issue with the control plane becoming more inefficient and the control plane load increasing with the number of use cases. The second option would have a significant impact on the air interface standard specification and could result in the 6G framework being entirely incompatible with the legacy 5G framework. Such a design would allow for several of the core issues with the AI/ML framework to be properly addressed. However, there will still be an issue of increased load on the control plane with the number of use cases. In addition, unless the new control plane is defined to have higher or adaptable bandwidth, there may be issues with low resource utilization or very latency for model transfer and model delivery.

In accordance with the third option noted above, an entirely new plane is developed. This plane can be termed the AI/ML plane or AMP plane 224 and may be designated for all AI/ML related traffic in the cellular network 202. The new AMP plane 224 is responsible for the AI/ML related data traffic and in particular for the data collection and model transfer described above. The AMP 224 may also be utilized for transfer of AI/ML model monitoring metrics between the different entities. For example, the AMP 224 may be designated for communication of AI/ML model monitoring metrics between a UE such as UE 218 and the cellular network 202 or from a RAN node such as the DU 210 to core network 206. Furthermore, the AMP 224 can be designed to manage LCM aspects of an AI/ML model. Such LCM aspects may include AI/ML model functionality activation, deactivation, switching and fallback. In this manner all AI/ML-related aspects can be managed from within the new AMP 224. This may enable design of new use cases quickly and efficiently for native AI/ML. Furthermore, having such a design for the native AI/ML framework permits some backward compatibility of 6G radio with 5G as the AMP 224 is transparent to 5G radios.

The new AMP 224 combines the benefits of both the control plane 220 and the user plane 222 solutions. Generally, all the traffic in the AMP 224 is intended to originate and terminate at a UE device or the different entities in the network, similar to traffic on the control plane 220. However, the data traffic with regards to model transfer and model delivery and data collection requirements are similar to user plane traffic. Similar to the control plane traffic, the traffic at the AMP 224 will generally not be charged to the user.

Furthermore, the AMP 224 will likely compete with the user plane 222 for the bandwidth to transfer large datasets and models. For the monitoring metrics and LCM for the AI/ML model, a dedicated fixed bandwidth may be allocated to the AMP 224 to support AI/ML models for the users in the network. However, for the model transfer and model delivery and data transfer there will be a scheduling aspect like the user plane. In embodiments, a scheduler 250 determines how to coordinate assignment of the bandwidth in the cellular network 202 between the AMP 224 and the user plane 222, depending on the network condition and the QoS requirements, for example. As depicted in FIG. 2A, the scheduler 250 is arranged in the RAN such as the CU 208 to perform radio resource management, but the present disclosure is not limited thereto. The scheduler 250 may be located in other parts of the RAN, such as the DU 210. Furthermore, based on the network conditions, it may be desirable to disable or turn off AI/ML communication on the AMP 224 for some or all users in the system. This may be done, for example, for power saving at the cellular network 202 when there are very few users in the system and AI/ML model gains are limited.

The AMP 224 may operate to transfer AI/ML related data across multiple layers and entities in the network. The AMP 224 may transfer AI/ML data originating from UE 218, DU 210, CU 208, the OAM 204 including the RIC 214, and the core network 206. The AMP 224 may terminate the AI/ML data at a UE such as UE 218, for LCM data for an AI/ML model, model transfer and model delivery, and for some model monitoring aspects. Further, the AMP 224 may terminate the AI/ML data at DU 210, CU 208 and OAM 204.

As the native AI/ML will be present across different layers and entities in the cellular network 202, several of these entities may be designed by different vendors. In particular, UE devices served by the network may be sourced by a wide variety of vendors. The native AI/ML models may be designed in a manner that these AI/ML models support inter-vendor collaboration. For example, an AI/ML model should support hardware of different vendors. Furthermore, the native AI/ML models present at the different layers should not impact the performance of each other. Having AMP 224 provide communication of standardized data across different entities, will enable inter vendor collaboration by design.

Similarly, AI/ML models at different entities can share their performance metrics or assistance information by communicating such information over AMP 224 to other AI/ML models to avoid any performance impact between each other. The assistance information from the AI/ML models at different layers can also assist in training the AI/ML models.

The AMP 224 will allow for much better data management as the network can collect data for multiple use cases simultaneously, thereby improving efficiency. For example, there may be some common inputs for different AI/ML models. Furthermore, the cellular network 202 can add relevant additional information and labels to the data communicated on the AMP 224. The network can also ensure that all the privacy, proprietary and security aspects of the data are properly addressed before the data is shared with the cellular network 202 or UE vendors to develop UE models. Additionally, use of the AMP 224 gives the cellular network 202 control over when to collect data or transfer models so that there is minimal impact on system performance. Finally, the architecture of the AMP 224 provides a good framework that can be used to quickly develop and deploy AI/ML use cases based on the network requirements. Use of the AMP 224 will also reduce the standardization effort needed to develop new AI/ML use cases as only the data that is needed to be transferred and where and who it should be sent to needs to be discussed.

In the exemplary embodiment of FIG. 2A, the core network 206 includes an artificial intelligence/machine learning plane (AMP) 224 in addition to the control plane 220 and the user plane 222. The AMP 224 in this example includes AI/ML core functions 242 and the data collection server 225 which stores AI/ML data 246. The data collection server 225 may not need to be arranged in the core network 206 and can be located in other parts of the mobile communication network. Other embodiments may include additional or fewer features and some of the described functions may be combined or modified.

The AI/ML core functions 242 include hardware and software to implement necessary functions of the AMP 224. The AI/ML core functions 242 may communicate data with other components of the system 200 using or controlling the AMP 224. For example, the AI/ML core functions 242 may communicate with the CU 208, DU 210 and OAM 204 of the cellular network 202. Further, the AI/ML core functions 242 may cooperate with UEs such as the UE 218 to route AI/ML data of an AI/ML model 218a installed on the UE 218, including transferring the AI/ML model over the cellular network 202 to the UE 218. The AI/ML core functions 242 may cooperate with aspects of functional features of the control plane 220 and the user plane 222 for managing AI/ML data and functions in the cellular network 202 and the core network 206.

The AI/ML models 244 include models that may be deployed to a UE such as UE 218, models that require training including training data, and AI/ML parameter data used for such models. When the AMP 224 deploys a particular AI/ML model to a UE or to another network component, the model may be selected from or drawn from the AI/ML model 244. In some examples, because of large data storage requirements, such AI/ML models 244 may be stored or maintained, for example, in a network slice or other network-accessible location.

The AI/ML data functions 246 corresponds to data associated with one or more AI/ML models in the cellular network 202. Such AI/ML data functions 246 may include training data for a particular model such as AI/ML model 218a at a particular UE such as UE 218. Such AI/ML data functions 246 may correspond to training data for a class of models or a subset of models of the AI/ML models 244. Further, the AI/ML data functions 246 may correspond to results of AI/ML operation received from one or more UEs or one or more network elements and intended for communication to a user, such as via the PGW 240. The training data may be transferred to a training server, for example, using a data collection framework. After the model is developed, a similar framework for data collection is needed for model transfer and delivery to transfer and deploy the model to the entities responsible for inference using the AI/ML model.

The AI/ML LCM function 248 implements functions required for managing the life cycle of AI/ML models in the system 200. The life cycle may include activation and deactivation of particular models or classes of models in the system 200, for example, and may include monitoring of metrics for such models for performance issues that may require review of the model. The AI/ML LCM function 248 is readily scalable as the number of AI/ML models and use cases increase.

The scheduler 250 operates to control use of resources of the AMP 224. The AMP 224 may communicate very large amounts of data. An AI/ML model has the potential to utilize and process large amounts of data related to training and optimization and to generate an output for the given problem. The AMP 224 generally operates independently of the control plane 220 and the user plane 222. In one or more embodiments, the AMP 224 can be independently operated from the control plane and/or user plane in a number of different ways including independently controlled, instructed, commanded and/or managed. Also, in one or more embodiments the independent operation of the AI/ML plane allows for differential treatment or handling of the AI/ML traffic as compared to user and/or control traffic, where the AI/ML traffic can be managed by the same or different devices (e.g., servers, routers, virtual machines and/or other network elements) as compared to user and/or control traffic. In one or more embodiments, one or more functions described in 3GPP for operating or managing the user plane and/or the control plane can be extended to some of the functionality described with respect to the AI/ML plane.

Independent operation of the AMP 224, UP 222 and CP 220 may be illustrated in many examples. The AMP 224 is designed to function independently from the CP 220 and the UP 222, similarly to how the CP 220 and the UP 222 are designed to function independently from each other. This independence is achieved through network function virtualization (NFV) and software defined networking (SDN) which enable the virtualization of network functions and decoupling of the control logic from the underlying hardware, leading to independent management and orchestration of the three planes, CP, AMP, UP.

The service-based architecture at the core network 206, where network functions are implemented as services, allows AMP functions (AI/ML functions in the core network 206), and the UPF (user plane functions), and the CP functions (control plane functions, e.g. AMF) to operate independently and interact through specific interfaces. Further, the CP 220, UP 222, and AMP 224 functions can be handled by different network functions. Lastly, the interfaces that are used for the different types of traffic, CP, UP, and AMP can be different, between gNB and core network.

While the AMP 224 operates independently of the control plane 220 and the user plane 222, the AMP 224 shares network facilities of the cellular network 202 for data communication. In particular, the cellular network 202 can convey large amounts of user data, especially during busy times for the network during the day and the week. The bandwidth and other capacity measures of the cellular network 202 must be shared between the user plane 222 and the AMP 224.

The scheduler 250 operates to determine how to share network resources such as bandwidth between the AMP 224 and user plane 222, depending on the network condition and on QoS requirements. QoS requirements set relative priorities for user data based, for example, on an application used by a UE. For example, a UE assigned to a first responder gets relatively high priority on the network and thus is assigned a corresponding QoS. Also, a user accessing an online gaming application may require very low latency and is thus assigned a corresponding QoS. On the other hand, a user downloading a file such as a video does not require low latency and may thus be assigned a QoS value appropriate to that activity. Similarly, communication of AI/ML data collection may have a relatively low priority, depending on the nature of the data, the amount of data and the model under consideration. Furthermore, based on network conditions, the scheduler 250 may also decide to disable or turn off AI/ML functionality for some or all users in the system. The scheduler 250 may do this, for instance, for power saving at the network when there are very few users in the system and AI/ML model gains are limited. In the embodiment of FIG. 2A, the scheduler 250 is shown as part of the RAN in the CU 208. In some embodiments, the scheduler 250 may be located elsewhere such as the DU 210.

FIG. 2B depicts an illustrative embodiment of a method 260 in accordance with various aspects described herein. The method 260 may be performed by network elements of a cellular network such as cellular network 202 implementing an AI/ML plane such as AMP 224 illustrated in FIG. 2A. The method 260 may be initiated by any action involving one or more AI/ML models in the cellular network including an individual AI/ML model operating on a UE such as UE 218 or on a network component of the RAN or elsewhere in the network.

FIG. 2B illustrates method 260 for managing the lifecycle of AI/ML models within a mobile communications network, as depicted in FIGS. 1 and 2A. This method is implemented in conjunction with the artificial intelligence/machine learning plane (AMP) 224, which operates in parallel with the control plane (CP) 220 and user plane (UP) 222, as shown in FIG. 2A.

The process begins with step 262, where training data is collected. This step is facilitated by the AMP 224, which manages data collection across multiple network entities, including user equipment (UE) 218, distributed units (DU) 210, centralized units (CU) 208, and operations, administration, and maintenance (OAM) functions 204, as depicted in FIG. 2A.

Model training is one of the main steps of model development. Training is a process to train the AI/ML model, for example, by learning the input/output relationship, in a data driven manner and to obtain the trained AI/ML model for inference. To train even a simple AI/ML model requires collecting large amounts of historical data from one or multiple entities across the network. The training data may then be transferred to a training server using a data collection framework. The training server may manage the model training process. The size of the training dataset can be in the range of 100k to 100M data samples, depending on various aspects such as the use case, the type of model being trained, generalization aspects etc. Similarly, the model size can vary from 10k to 100M parameter model depending on the use case, the model type and other aspects. Due to the large amount of data involved, it is important that the network has full visibility and control over when the data is shared to avoid any network impact. The AMP 224 provides the requisite visibility and control. Additionally, the users may not be charged for the AI/ML model training data or model transfer.

In step 264, the collected data is used to train the AI/ML model. The AI/ML core functions 242 within the AMP 224 may be responsible for processing this data and training the models, which are stored in the AI/ML models 244, in embodiments. In some embodiments, cross layer AI/ML models where inputs from one or multiple layers are used to train a model, and the AI/ML model output can be used by one or multiple layers. A cross-layer ML model is a machine learning model that leverages information and interactions across different layers of the communication stack (e.g., physical, link, network, transport, application). The cross-layer ML model considers information and constraints from multiple layers simultaneously to make more informed decisions and optimize overall system performance.

Once the model is trained, step 266 involves deploying the model to the relevant network entities, such as the UE 218 or other components within the network, as shown in FIG. 2A. This deployment is managed by the AMP 224, ensuring that the model is delivered to the appropriate entities for inference.

Step 268 activates the deployed model, enabling it to perform its designated functions within the network. The AMP 224 manages this activation process, ensuring that the model is operational and ready for use.

The model's performance is then monitored in step 270. The AI/ML life cycle management (LCM) function 248 within the AMP 224 may oversee this monitoring, collecting performance metrics and ensuring that the model operates as expected.

If the model's performance is deemed acceptable in step 272, the process continues without changes. The method 260 may operate in a loop including step 270 and step 272 until a modification is determined to be necessary. If performance issues are detected at step 272, the method proceeds to step 274, where the system determines whether model parameters need updating. This may occur if new training data has been received, or new models are received, or other modifications have occurred in the network. If model parameters are to be updated, step 276 updates the parameters, leveraging the AI/ML data functions 246 managed by the AMP 224. The new model parameters may be communicated over the cellular network under control of the AMP 224.

If a more significant update is required, step 278 involves updating the entire model. This step ensures that the model remains effective and relevant to the network's needs. The model may be updated in any suitable manner, such as by removing an existing model from the network element and replacing it with a new or revised model.

In cases where a different model is more suitable, step 280 involves switching to an alternative model. The AMP 224 facilitates this switch, ensuring seamless transitions between models.

Finally, if the model is no longer needed or effective, step 284 deactivates the model, removing it from active use within the network. This deactivation is managed by the AMP 224, ensuring efficient resource allocation and network performance.

Overall, FIG. 2B outlines a comprehensive method for managing AI/ML models within a mobile communications network, leveraging the capabilities of the AMP 224 as depicted in FIG. 2A, and integrating with the broader network infrastructure shown in FIG. 1.

The subject matter of the disclosure can be enhanced through various alternate embodiments, as illustrated in FIG. 1, FIG. 2A, and FIG. 2B. One such embodiment involves distributed AI/ML processing, where instead of centralizing AI/ML processing within the AI/ML core functions 242, processing tasks are distributed across multiple network elements such as network elements 150, 152, 154, 156 in FIG. 1. This approach can enhance scalability and reduce latency by processing data closer to its source.

Another embodiment focuses on edge AI/ML deployment, implementing AI/ML models at the edge of the network, such as within the RU 212 or DU 210 in FIG. 2A, to enable real-time data processing and decision-making, which is particularly beneficial for latency-sensitive applications. Additionally, dynamic resource allocation can be enhanced by improving the scheduler 250 in FIG. 2A to dynamically allocate resources not only between the AMP 224 and user plane 222 but also among different AI/ML models based on real-time network conditions and priorities. Inter-device collaboration is another embodiment, enabling AI/ML models to collaborate across different devices, such as between UE 218 and media terminals 142 in FIG. 1, to optimize content delivery and user experience.

Enhanced security measures can be integrated within the AMP 224 to ensure secure data transfer and model deployment, addressing privacy concerns associated with AI/ML data traffic. Adaptive model management strategies can be implemented within the AI/ML LCM 248 to automatically adjust model parameters or switch models based on changing network conditions or user requirements, as depicted in FIG. 2B. Cross-layer optimization can be achieved by utilizing cross-layer AI/ML models that leverage data from multiple layers of the network stack, as shown in FIG. 2A, to optimize overall network performance and resource utilization. Integration with external networks can be facilitated by integrating the AMP 224 with external networks, such as content sources 175 in FIG. 1, to enhance data collection and model training capabilities. An AI/ML model marketplace can be developed within the network, allowing different vendors to offer models that can be dynamically deployed and managed by the AMP 224. Finally, user-centric AI/ML services can be tailored to individual user needs by leveraging data from user equipment 124 and 126 in FIG. 1, providing personalized network experiences. These alternate embodiments can enhance the flexibility, efficiency, and scalability of the AI/ML plane within the mobile communications network, aligning with the claims and overall objectives of the subject matter of the disclosure.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2C is a block diagram illustrating an example, non-limiting embodiment of channel mapping for a network for uplink and downlink communications such as functioning within the communication systems/networks 100 and 200 of FIGS. 1 and 2A, respectively, in accordance with various aspects described herein. The mappings 285 and 286 can correspond to uplink and downlink channels, respectively, of various types (e.g., logical, transport, and physical) such as to be used in a cellular network. In embodiments, the cellular network may be owned and operated by a mobile network operator (MNO), also referred to as a cellular service provider (CSP).

In a mobile communication network, logical channels, transport channels, and physical channels can serve distinct roles in the transmission of data, each operating at different layers of the communication protocol stack. Logical channels can be defined by the type of information they carry and can be primarily concerned with the nature of the data being transmitted. Logical channels are generally categorized into control channels, which carry signaling and control information, and traffic channels, which carry user data; and according to the embodiments described herein can include an AMCCH for AI/ML-related data. They can operate at the higher layers of the protocol stack and can be responsible for ensuring that data is appropriately categorized and prioritized based on its type and importance.

Transport channels can be responsible for the actual transmission of data over the air interface between the UE and the network. They define how data is transferred over the radio interface, specifying the format and structure of the data packets. Transport channels can be mapped to logical channels and can be responsible for adapting the data to the physical layer's requirements. They can operate at the MAC layer and can be important for managing the flow of data across the network.

Physical channels can operate at the physical layer and can be concerned with the actual transmission of data over the radio waves. Physical channels can define the specific radio frequency resources used for data transmission, including time slots, frequency bands, and modulation schemes. They can be responsible for the physical transmission and reception of data, converting the data packets into radio signals that can be transmitted over the air. Physical channels can be mapped to transport channels and can be important for ensuring that data is transmitted efficiently and reliably over the network.

FIG. 2C illustrates AMCCH 2860 which is a logical channel specifically designed to carry AI/ML-related traffic with a primary function to provide a pathway (e.g., dedicated or exclusive in one embodiment) for AI/ML-related data, ensuring that it is not mixed with other types of traffic, such as control or user data. This separation allows for differential treatment of AI/ML traffic, enabling the network to prioritize and manage it according to its specific requirements. The Downlink Shared Channel (DL-SCH) 2862 and Uplink Shared Channel (UL-SCH) 2852 are transport channels that facilitate the transmission of data over the air interface. The AMCCH 2860 is mapped to these transport channels, which are responsible for adapting the logical channel data to the physical layer's requirements, and which can ensure that AI/ML-related data is formatted and structured appropriately for transmission over the network, managing the flow of data between the UE and the network. The Physical Downlink Shared Channel (PDSCH) 2864 and Physical Uplink Shared Channel (PUSCH) 2854 are physical channels that handle the actual transmission of data over the radio waves. These channels are responsible for converting the transport channel data into radio signals that can be transmitted over the air, and can define the specific radio frequency resources used for data transmission, ensuring that AI/ML data is transmitted efficiently and reliably across the network. By introducing the AMCCH 2860 and mapping it to specific transport and physical channels, the embodiments can provide a structured and efficient pathway for AI/ML traffic, optimizing its transmission and management within the network.

Additionally in FIG. 2C, other logical channels 2851, 2861 can include: a Broadcast Control Channel (BCCH) which can be used for broadcasting system information; a Common Control Channel (CCCH) utilized for transmitting control information common to all users; a Dedicated Traffic Channel (DTCH) designated for carrying user-specific data; a Dedicated Control Channel (DCCH) which is used for transmitting control information specific to a user; and a Paging Control Channel (PCCH) responsible for carrying paging information to alert user equipment of incoming calls or messages. Other transport channels 2863 can include: a Paging Channel (PCH) which is used to deliver paging messages to the user equipment; and a Broadcast Channel (BCH) which is used for broadcasting system information to all users. Other physical channels 2865 can include a Physical Broadcast Channel (PBCH) which carries important or essential system information required for initial access to the network; and a Physical Downlink Control Channel (PDCCH) responsible for carrying control information necessary for the scheduling of downlink and uplink transmissions. Other transport channels 2853 can include a Random Access Channel (RACH) which is a logical channel used by a UE to initiate communication with the network, which can be used for sending random access requests to establish a connection or to request resources from the network. Other physical channels 2855 can include: a Physical Random Access Channel (PRACH) is the physical channel associated with the RACH, which can be used to transmit the random access preamble from the UE to the network, allowing the network to allocate resources for further communication; and a Physical Uplink Control Channel (PUCCH) which is a physical channel used to carry uplink control information from the UE to the network, where this information can include acknowledgments for downlink data, channel quality indicators, and scheduling requests.

FIG. 2C illustrates the mapping of logical, transport, and physical channels for both downlink and uplink communications within a communication network, specifically focusing on the handling of AI/ML-related data/traffic. In the downlink section, labeled as 286, the logical channels, identified as 2861, include various types such as PCCH, BCCH, CCCH, DTCH, and DCCH. Among these, the AI/ML Control Channel, AMCCH, is highlighted as 2860. This logical channel is specifically designed to carry AI/ML-related traffic. The logical channels are mapped to transport channels, identified as 2863, with the DL-SCH being a key transport channel, labeled as 2862, for downlink traffic. The transport channels are further mapped to physical channels, identified as 2865, including PDSCH and PDCCH, with PDSCH being a primary channel, labeled as 2864, for the physical transmission of data.

In the uplink section, labeled as 285, the logical channels, identified as 2851, also include CCCH, DTCH, and DCCH, with the AMCCH, labeled as 2850, again being a focal point for AI/ML traffic. These logical channels are mapped to transport channels, identified as 2853, with the UL-SCH, labeled as 2852, serving as a crucial transport channel for uplink traffic. The transport channels are then mapped to physical channels, identified as 2855, such as PUSCH and PUCCH, with PUSCH being a significant channel, labeled as 2854, for the physical transmission of data.

Overall, FIG. 2C demonstrates the structured pathway for AI/ML traffic, ensuring it is efficiently managed and transmitted across the network by utilizing dedicated logical, transport, and physical channels. This setup allows for the differential treatment of AI/ML data, optimizing its handling within the network.

In one embodiment, the MAC layer prioritization for AI/ML-related data can include being classified as a distinct type of traffic with specific QoS requirements, where the classification involves assigning unique identifiers to AI/ML data flows, such as AI/ML-specific QFIs, which would help the MAC layer recognize and prioritize this traffic. The MAC layer can employ dynamic scheduling algorithms that prioritize AI/ML data based on its urgency and importance. For instance, data critical for real-time AI/ML model updates or inference can be given higher priority over less time-sensitive AI/ML data, such as bulk training data transfers. In one or more embodiments, prioritization can be applied within data types, such as prioritizing a first portion of AI/ML-related data over a second portion of AI/ML-related data, similar to prioritizing voice and video data over background file data. The MAC layer can allocate radio resources dynamically to AI/ML data flows, ensuring that they receive the necessary bandwidth and time slots to meet their performance requirements. This allocation can be based on the priority and QoS needs of the AI/ML data, ensuring efficient use of network resources, and further can ensure that high-priority traffic receives sufficient resources to meet its performance needs, while lower-priority traffic is allocated resources on a best-effort basis. Given that AI/ML data can have specific latency and throughput requirements, the MAC layer can optimize these parameters to ensure timely and reliable delivery. For example, low-latency paths can be prioritized for AI/ML inference data to ensure quick decision-making. The MAC layer can manage buffers to prioritize the queuing and transmission of AI/ML data. High-priority AI/ML data can be queued for immediate transmission, while lower-priority data might be buffered and transmitted as resources become available. The MAC layer can adapt link parameters, such as modulation and coding schemes, to optimize the transmission of AI/ML data under varying network conditions. Additionally, error handling mechanisms can prioritize retransmissions for important critical AI/ML data to maintain data integrity and reliability. The MAC layer can leverage AI/ML models to predict network conditions and adjust prioritization strategies dynamically. This integration can enable more intelligent and adaptive resource management, enhancing the overall efficiency of AI/ML data handling.

In one or more embodiments, prioritization conflicts can occur which can be resolved in a number of different ways. For example, a hierarchy of priorities can be established based on the criticality of the data. In one embodiment, a portion of network resources can be reserved for each type of data to ensure that critical data flows are not starved of resources. As an example, a minimum bandwidth allocation can be reserved for control data to ensure network stability, while the remaining resources are dynamically allocated between user and AI/ML data based on current demands. Adaptive resource management techniques can also be applied that leverage real-time network analytics and AI/ML models to predict traffic patterns and adjust resource allocation dynamically. This approach allows the network to respond to changing conditions and prioritize data flows based on current network load and performance requirements. Preemption policies can be implemented that allow higher-priority data to preempt lower-priority data in cases of resource contention. For instance, if a critical control message needs to be transmitted, it can preempt ongoing user data transmissions to ensure timely delivery. Load balancing and offloading techniques can be applied to distribute traffic across multiple network paths or offload non-critical data to less congested parts of the network. This can help alleviate congestion and ensure that high-priority data receives the necessary resources. Feedback mechanisms can be incorporated that monitor network performance and adjust prioritization strategies based on real-time feedback. This allows the network to continuously optimize resource allocation and resolve conflicts as they arise. By employing these strategies, a network can effectively manage prioritization conflicts amongst and between AI/ML data, user data, and control data, ensuring that each type of data receives the appropriate level of service based on its criticality and performance requirements.

Mapping between physical, transport, and logical channels can be an important process in mobile communications networks, ensuring that data is transmitted efficiently and accurately from the UE to the network and vice versa. This mapping can be managed through a series of signaling procedures and configurations that are communicated to the UE by the network. Logical channels and their mapping can include being defined by the type of information carried; and being configured by the network based on the service requirements and QoS parameters. This configuration can be communicated to the UE through RRC signaling messages, which specify the logical channels to be used for different types of data. Transport channels and their mapping can include defining how data is transmitted over the air interface, specifying the format and structure of the data packets. Physical channels and their mapping can be responsible for the actual transmission of data over the radio waves, defining the specific radio frequency resources used for data transmission.

The RRC protocol is responsible for configuring and managing the mapping of logical, transport, and physical channels. It provides the UE with the necessary configuration parameters and updates as network conditions change. DCI messages are used to convey scheduling information to the UE, including the allocation of physical resources for data transmission. These messages are transmitted over the PDCCH.

In one or more embodiments, AI/ML-related data, user data, and/or control data can share or otherwise utilize a same physical channel, even though they are transmitted over different logical channels. This can optimize the use of available radio resources. In one embodiment, each type of data—AI/ML, user, and control—can be assigned to different logical channels based on the nature and requirements of the data.

FIG. 2D depicts an illustrative embodiment of a method 288 in accordance with various aspects described herein. The method 288 may be performed by network elements of a cellular network such as cellular network 202 implementing an AI/ML plane such as AMP 224 illustrated in FIG. 2A. The method 288 may be initiated by, or for the purposes of, facilitating any action involving one or more AI/ML models in the cellular network including an individual AI/ML model operating on a UE such as UE 218 or on a network component of the RAN or elsewhere in the network.

FIG. 2D illustrates method 288 for mapping of channels including a logical channel AMCCH and associating the AMCCH with a radio bearer (e.g., AMRB) to provide efficient handling of AI/ML traffic across the RAN which allows for a number of performance efficiencies including the MAC layer performing multiplexing and demultiplexing of AI/ML traffic based on the priority of the data, thereby facilitating differential treatment of the AI/ML data within a communications network, as depicted in FIGS. 1 and 2A. This method 288 can be implemented in conjunction with uplink and downlink channel mappings 285, 286 of FIG. 2C and the AMP 224, which operate in parallel with the control plane 220 and user plane 222, as shown in FIG. 2A. Other configurations of user and control planes, as well as other configurations of components and functionality that may include (or be distinct from) those depicted in FIG. 2A can also be utilized in conjunction with method 288.

At 2880, a logical channel can be established for AI/ML traffic. This can be done in a number of different ways including various messaging and defining channel parameters to make it distinct from other logical channels used for control or user data.

At 2882, mapping of the logical channel with transport and physical channels can be performed. This can include mapping the logical channel to a DL-SCH and a PDSCH for downlink traffic, as well as to a UL-SCH and a PUSCH for uplink traffic. The mapping can be facilitated by Radio Resource Control (RRC) messaging, ensuring that both base stations and UEs are aware of the channel configurations. In one embodiment, the RRC messaging can be similar to that described in the 3GPP standard, such as in format, procedures, and so forth.

At 2884, the logical channel is associated with a radio bearer (e.g., AMRB). This association provides efficient handling of AI/ML-related data across the RAN, optimizing or improving the network's ability to manage AI/ML traffic. The logical channel can enable the MAC layer to perform multiplexing and demultiplexing based on the priority of the AI/ML data, such as according to its QoS requirements. As an example, the logical channel can be linked to a specific communication path that carries the AI/ML-related data. The radio bearer can be a service provided by the network that defines the characteristics and parameters for data transmission, such as latency, throughput, and reliability.

It should be understood that the radio bearer can be a dedicated or non-dedicated radio bearer. In one embodiment, a dedicated radio bearer with end-to-end connectivity across a RAN can be utilized which is a specific communication channel established between a user device (such as a smartphone or IoT device) and the core network, designed to carry a particular type of traffic (e.g., AI/ML-related data) with specific QoS requirements. In one embodiment, dedicated radio bearers can be used for services that require guaranteed performance, such as voice calls, video streaming, and/or AI/ML data transmissions. In one embodiment, end-to-end connectivity can be provided such that the communication path is established from the originating device through the RAN and all the way to the core network, ensuring seamless data transmission across the entire network infrastructure. This connectivity involves multiple network elements, including base stations (e.g., eNodeB in 4G or gNodeB in 5G), the RAN, and the core network components, which work together to maintain the integrity and performance of the data flow.

In another embodiment, a shared radio bearer can be utilized, which can be a more flexible and resource-efficient approach for handling traffic in a communication network. Shared radio bearers can carry multiple data flows from different users or applications over the same channel. This approach allows for more efficient use of network resources, as the available bandwidth is dynamically allocated based on current demand and network conditions. Shared bearers provide greater flexibility in managing network resources, as they can accommodate varying traffic loads and adapt to changes in user demand. This is particularly useful in scenarios where traffic patterns are unpredictable or highly variable. As an example, the network can employ adaptive scheduling algorithms to allocate resources to different data flows based on their priority and QoS requirements. This ensures that high-priority traffic receives the necessary resources while optimizing the overall utilization of the network. Shared bearers enable load balancing across the network, distributing traffic more evenly and preventing congestion in specific areas. This helps maintain consistent performance and reduces the risk of bottlenecks.

In one embodiment, by sharing resources among multiple users, the network can reduce the overhead associated with maintaining multiple dedicated bearers. This can lead to cost savings in terms of both infrastructure and operational expenses. Shared bearers are inherently more scalable, as they can accommodate a growing number of users and devices without the need for additional dedicated resources. This is particularly advantageous in densely populated areas or during peak usage times. Shared bearers can be well-suited for non-critical applications and services that do not require guaranteed QoS. These applications can tolerate variable performance and are typically served on a best-effort basis.

In one or more embodiments, the MAC layer can perform multiplexing and demultiplexing based on prioritization by combining multiple data streams into a single transmission channel and then separating them back into individual streams, all while considering the priority of each data stream. Multiplexing allows combining multiple data streams or logical channels into a single transport channel for transmission over the air interface in order to efficiently utilize available bandwidth and resources. During multiplexing, the MAC layer considers the priority of each data stream, where high-priority data can be given precedence over lower-priority data so that critical data is transmitted with minimal delay and meets its QoS requirements. The MAC layer allocates resources such as time slots and frequency bands based on the priority of the data streams where this dynamic allocation helps maintain the desired performance levels for high-priority traffic. Demultiplexing is the reverse process of multiplexing, where the combined data stream received over the transport channel is separated back into individual logical channels at the receiving end. During demultiplexing, the MAC layer ensures that high-priority data is processed and delivered first. This can facilitate maintaining the QoS requirements of time-sensitive applications.

FIG. 2E depicts an illustrative embodiment of a method 290 in accordance with various aspects described herein. The method 290 may be performed by various devices including user devices and network elements of a cellular network such as cellular network 202 implementing an AI/ML plane such as AMP 224 illustrated in FIG. 2A. The method 290 may be initiated by, or for the purposes of, facilitating any action involving one or more AI/ML models in the cellular network including an individual AI/ML model operating on a UE such as UE 218 or on a network component of the RAN or elsewhere in the network.

FIG. 2E illustrates method 290 for managing PDCPs, AMRBs, and/or AMAPs, which can include establishing a logical channel AMCCH and associating the AMCCH with the AMRB to provide efficient handling of AI/ML traffic across the RAN which allows for a number of performance efficiencies including the MAC layer performing multiplexing and demultiplexing of AI/ML traffic based on the priority of the data, thereby facilitating differential treatment of the AI/ML data within a communications network, as depicted in FIGS. 1 and 2A. This method 290 can be implemented in conjunction with uplink and downlink channel mappings 285, 286 of FIG. 2C and the AMP 224, which operate in parallel with the control plane 220 and user plane 222, as shown in FIG. 2A. Other configurations of user and control planes, as well as other configurations of components and functionality that may include (or be distinct from) those depicted in FIG. 2A can also be utilized in conjunction with method 290.

In one embodiment, the Packet Data Convergence Protocol (PDCP) entity can be an important component in the protocol stack of cellular networks, which can operate at the data link layer and can be responsible for functions that facilitate efficient data transmission between the user equipment and the network. The PDCP can compress the headers of IP packets to reduce the amount of data that needs to be transmitted over the air interface, thereby improving bandwidth efficiency. The PDCP provides encryption and integrity protection for user data, ensuring that the data is secure during transmission. The PDCP ensures that data packets are delivered in the correct order and detects any duplicate packets, which is important for maintaining the quality of service and reliability of the communication. In the event of packet loss or out-of-order delivery, the PDCP can reorder packets and request retransmission, ensuring that the data stream remains consistent and complete. The PDCP can handle multiple data radio bearers, allowing it to manage different types of traffic with varying QoS requirements.

In one embodiment, the AMRB is configured to carry AI/ML data, ensuring that this traffic is not mixed (e.g., within a logical channel) with other types of data, and by providing a separate logical channel for AI/ML data, the AMRB allows for specific QoS parameters to be applied, such as prioritization and scheduling, which are tailored to the needs of AI/ML applications. Security is an important aspect of the AMRB, as it ensures the confidentiality, integrity, and authenticity of the AI/ML data being transmitted. The AMRB utilizes security mechanisms to protect the data from unauthorized access and tampering. The AMRB can employ encryption techniques to secure the data being transmitted. The AMRB can use integrity protection mechanisms to ensure that the data has not been altered during transmission. This involves generating and verifying integrity check values for the data packets. The AMRB may also implement authentication procedures to verify the identity of the entities involved in the communication, ensuring that only authorized devices can send and receive AI/ML data.

The AMRB configuration process can involve establishing a PDCP entity, which handles the encryption and integrity protection of the data. Specific security parameters are configured for the AMRB, such as encryption algorithms and keys, to ensure robust protection of the AI/ML data. By implementing these security measures, the AMRB ensures that AI/ML data is transmitted securely, maintaining the integrity and confidentiality of the information as it traverses the network.

In one embodiment, the AI/ML Application Protocol (AMAP) can be a layer within the protocol stack of a cellular network, specifically designed to handle AI/ML data traffic. The AMAP serves as an interface between the AI/ML plane and other layers of the network protocol stack, facilitating the efficient transmission and management of AI/ML data. The AMAP can provide a structured way to integrate AI/ML data handling into the existing network protocol stack, ensuring seamless communication between AI/ML applications and network resources. The AMAP can manage the flow of AI/ML data across the network, ensuring that data is transmitted efficiently and in accordance with the specific requirements of AI/ML applications. The AMAP can interface with lower layers of the protocol stack, such as the RRC layer, to configure and manage the AMRB and logical channels (e.g., AMCCHs). The AMAP can support various AI/ML operations, such as data collection, model training, and lifecycle management, by providing the necessary protocol support for these activities. The AMAP can enable the AMP to function effectively within the network.

In one embodiment, a dedicated protocol layer for AI/ML data is provided where the AMAP ensures that this data is handled with the appropriate level of priority and security, optimizing the performance of AI/ML models and applications. This integration allows for more efficient use of network resources and supports the deployment of advanced AI/ML use cases in next-generation cellular networks.

At 2902, the PDCP entity can be established which allows for managing the transmission of AI/ML-related data, ensuring efficient data handling through tasks such as header compression and decompression. Following this, the method involves configuring the security for the AMRB, as shown by reference 2904. This configuration can include selecting encryption algorithms, generating encryption keys, and/or applying integrity protection mechanisms to ensure secure data transmission across the network. At 2906, the AMAP entity can be established which serves as an interface between the AI/ML plane and other layers of the communication network, managing AI/ML data flow and control signaling. This setup allows for dynamic adjustment of data flow parameters based on network conditions and AI/ML model parameters, optimizing network performance and resource utilization.

FIG. 2F depicts an illustrative embodiment of a method 292 in accordance with various aspects described herein. The method 292 may be performed by various devices including user devices and network elements of a cellular network such as cellular network 202 implementing an AI/ML plane such as AMP 224 illustrated in FIG. 2A. The method 292 may be initiated by, or for the purposes of, facilitating any action involving one or more AI/ML models in the cellular network including an individual AI/ML model operating on a UE such as UE 218 or on a network component of the RAN or elsewhere in the network.

FIG. 2F illustrates method 292 for managing PDCPs and AMRBs including their releases. This method 292 can be implemented in conjunction with method 290 of FIG. 2E for establishing PDCPs, AMRBs and/or AMAPs, and/or can be implemented in conjunction with uplink and downlink channel mappings 285, 286 of FIG. 2C and the AMP 224, which operate in parallel with the control plane 220 and user plane 222, as shown in FIG. 2A. Other configurations of user and control planes, as well as other configurations of components and functionality that may include (or be distinct from) those depicted in FIG. 2A can also be utilized in conjunction with method 292.

Releasing a bearer in a cellular network context can be the process of terminating a specific radio bearer that has been established between the UE and the network. A radio bearer can carry data between the UE and the network, and it is associated with specific QoS parameters. Releasing a bearer is typically done to free up network resources, adjust to changing network conditions, and/or when the data session associated with the bearer is no longer needed.

The release of a bearer can be triggered by various conditions, such as the completion of a data session, a change in network policy, and/or a need to reallocate resources to other users or services. The release process can be initiated through RRC signaling messages. The network (e.g., base station) can send an RRC Connection Reconfiguration message to the UE, which includes instructions to release specific bearers. The message may contain a list of bearers to be released, often referred to as the ToReleaseList. This list specifies the identifiers of the bearers that need to be terminated.

Upon receiving the RRC message, the UE can perform the necessary actions to release the specified bearers. This includes stopping the transmission and reception of data on those bearers and freeing up any associated resources. The network can also update its configuration to reflect the release of the bearers, ensuring that resources are reallocated as needed. In some cases, the UE may send a confirmation message back to the network to acknowledge the successful release of the bearers. Releasing a bearer can be an important part of managing network resources efficiently, ensuring that the network can adapt to dynamic conditions and maintain optimal performance for all users.

In one embodiment, an AMRB-ToReleaseList can be included in RRC protocol messaging used in cellular networks to manage the configuration of radio bearers, specifically for the AMRB. This list can be included in RRC signaling messages to instruct the UE to release specific AI/ML radio bearers.

In one embodiment, an RRC connection reconfiguration message can be used to modify the configuration of an existing RRC connection. It can include the AMRB-ToReleaseList to specify which AI/ML radio bearers need to be released. This message can be important for adapting the connection parameters to changing network conditions or service requirements. As an example, the UE receives RRC messages from the network and acts upon them to release the specified AI/ML radio bearers. The base station manages the radio resources and sends RRC messages to the UE. It uses the AMRB-ToReleaseList to instruct the UE as to which AI/ML radio bearers to release.

The exchange of RRC messages, including those containing the AMRB-ToReleaseList, can be an important part of the operations in a cellular network. These messages ensure that the UE and the network are synchronized in terms of radio bearer configurations, enabling efficient and reliable communication. Releasing AI/ML radio bearers helps optimize network resource allocation and maintain overall network performance.

At 2922, the PDCP entity can be released, which is responsible for managing data transmission tasks such as header compression and decompression. Following the release of the PDCP, the method proceeds to release the AMRB, as shown by reference 2924. The AMRB can be a bearer for AI/ML traffic, and its release involves freeing up the resources allocated for AI/ML data transmission. At 2926, relevant network components can be notified of the releases. This notification ensures that all layers of the network are updated regarding the release of the PDCP and AMRB, allowing for efficient reallocation of resources and maintaining optimal network performance.

FIG. 2G depicts an illustrative embodiment of a configuration table 294 for configuration parameters or other information that can be utilized for the logical channel in accordance with various aspects described herein. Parameter names 2942, values 2944, and descriptions 2946 are illustrated. Other configuration parameters or information can also be utilized. AMRB can carry messages, such as using the AMCCH logical channel. The AMCCH logical channel can have message types including: DL-AMCCH-Message which is sent from the network to the UE on the downlink AMCCH logical channel and UL-AMCCH-Message which is sent from the UE to the network on the UL AMCCH logical channel.

The AMCCH channels can be configured inside the RRC layer. Like other logical channels, AMCCH can have various configuration parameters including, but not limited to: protocol layer configurations (e.g., configurations for AMAP, PDCP, RLC); and logical channel configurations (e.g., priority of the channel, prioritised bit, bucket size duration, logical channel group.

Table 294 outlines some parameters for setting up a logical channel within a communication network. The table 294 includes several components, starting with the AMAP configuration, which specify the settings for the AI/ML Application Protocol. This is followed by the PDCP configuration, which details the parameters for the Packet Data Convergence Protocol, ensuring efficient data handling. The RLC configuration value (listed under values 2944) is set to TM, indicating the use of Transparent Mode for the Radio Link Control layer. The logical channel configuration includes several important parameters: priority is set to 1, indicating the highest priority level; the prioritised bit is set to infinity, ensuring that the channel is always prioritized; the bucket size duration is specified as 1000 ms, defining the time interval for data transmission; and the logical channel group is set to 0, categorizing the channel within the network's logical structure. This comprehensive configuration can facilitate the logical channel being optimized for handling AI/ML data with the necessary priority and efficiency.

FIG. 2H depicts an illustrative embodiment of a method 296 in accordance with various aspects described herein. The method 296 may be performed by various devices including network elements, user devices, and so forth of a cellular network such as cellular network 202 implementing an AI/ML plane such as AMP 224 illustrated in FIG. 2A. The method 296 may be initiated by, or for the purposes of, facilitating any action involving one or more AI/ML models in the cellular network including an individual AI/ML model operating on a UE such as UE 218 or on a network component of the RAN or elsewhere in the network.

FIG. 2H illustrates method 296 for provisioning configuration messages that enable a logical channel AMCCH and associating the AMCCH with a radio bearer (e.g., AMRB) to provide efficient handling of AI/ML traffic across the RAN which allows for a number of performance efficiencies including the MAC layer performing multiplexing and demultiplexing of AI/ML traffic based on the priority of the data, thereby facilitating differential treatment of the AI/ML data within a communications network, as depicted in FIGS. 1 and 2A. The provisioned configuration messages can include various configuration parameters, including information in table 294 of FIG. G or other information that facilitates operation of the AMP, AMCCH, AMRB or other features described herein. This method 296 can be implemented in conjunction with uplink and downlink channel mappings 285, 286 of FIG. 2C and the AMP 224, which operate in parallel with the control plane 220 and user plane 222, as shown in FIG. 2A. Other configurations of user and control planes, as well as other configurations of components and functionality that may include (or be distinct from) those depicted in FIG. 2A can also be utilized in conjunction with method 296. In one embodiment, the messaging can include an AMRB-ToAddModList, which can have various fields such as: cnAssociation; amrb-Identity; reestablishPDCP; recoverPDCP; and amap-Config.

In the context of 3GPP standards, the ToAddModList (or AMRB-ToAddModList) can be associated with the Radio Resource Control (RRC) protocol, which is used for configuring radio bearers and managing connections between the UE and the network, whereby an RRC connection reconfiguration message can be used to modify the configuration of an existing RRC connection. For example, it can include the ToAddModList (or AMRB-ToAddModList) to specify which radio bearers need to be added or modified. During the initial setup of an RRC connection, the ToAddModList (or AMRB-ToAddModList) can be used to define the initial set of radio bearers that need to be established for the UE. The wireless device can receive RRC messages from the network and configures its radio bearers accordingly. The base station can be responsible for managing the radio resources and sending RRC messages to the UE. It can use the ToAddModList (or AMRB-ToAddModList) to instruct the UE on which radio bearers to add or modify.

At 2962, configuration messaging can be provided, which can involve transmitting a message from a base station to a communication device, detailing the configuration parameters for a logical channel dedicated to AI/ML-related data. This logical channel operates within a network architecture that includes a control plane, a user plane, and an AMP, with the latter functioning independently and in parallel with the other planes.

Following the configuration messaging, at 2964, communication can occur on the Downlink AI/ML Control Channel (DL-AMCCH). This step ensures that AI/ML-related data is transmitted from the base station to the communication device via the downlink logical channel, allowing for efficient data handling and prioritization based on network conditions and AI/ML model parameters.

At 2966, communication can occur on the Uplink AI/ML Control Channel (UL-AMCCH). This step facilitates the transmission of AI/ML-related data from the communication device back to the base station via the uplink logical channel. The process ensures that the AI/ML data traffic is managed effectively, with the MAC layer performing multiplexing and demultiplexing based on the priority of the data. This setup allows for dynamic adjustment of data flow parameters, optimizing network performance and resource utilization.

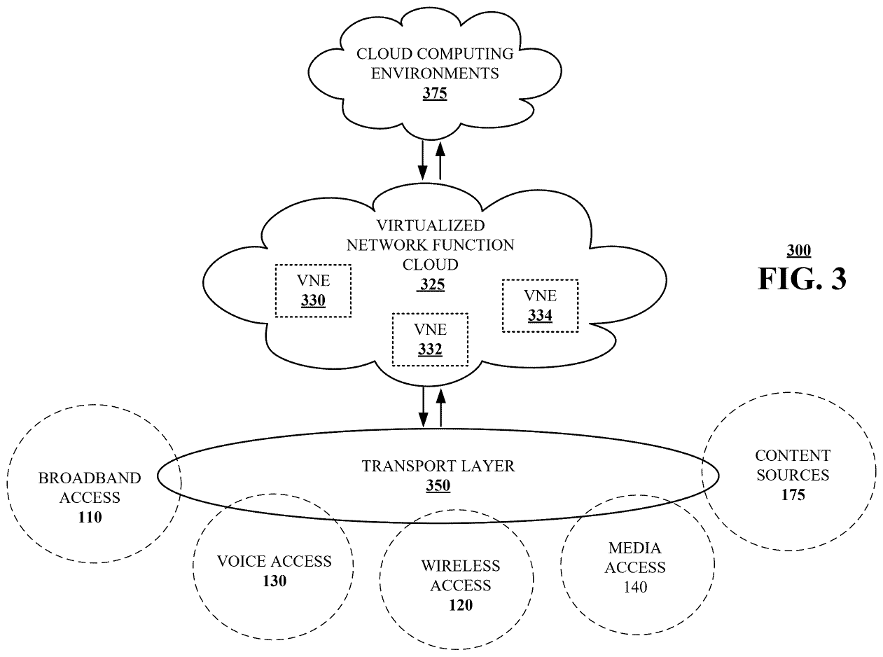

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of systems, the subsystems, functions and methods described herein. For example, virtualized communication network 300 can facilitate in whole or in part implementing a control plane and a user plane for managing operation of a mobile communication network; and implementing, by the processing system, an artificial intelligence/machine learning plane within the communication network that utilizes a logical channel for carrying AI/ML-related data, wherein the logical channel is mapped to a transport channel and a physical channel. Various configuration parameters can be utilized and provisioned for features of the AMP including the logical channel or the AMRB.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

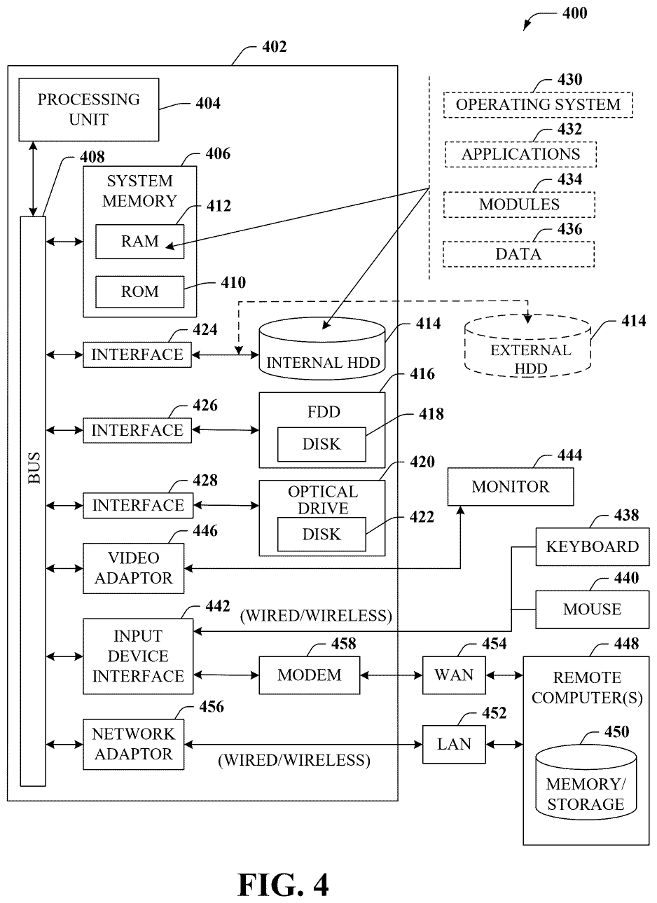

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part implementing a control plane and a user plane for managing operation of a mobile communication network; and implementing, by the processing system, an artificial intelligence/machine learning plane within the communication network that utilizes a logical channel for carrying AI/ML-related data, wherein the logical channel is mapped to a transport channel and a physical channel. Various configuration parameters can be utilized and provisioned for features of the AMP including the logical channel or the AMRB.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

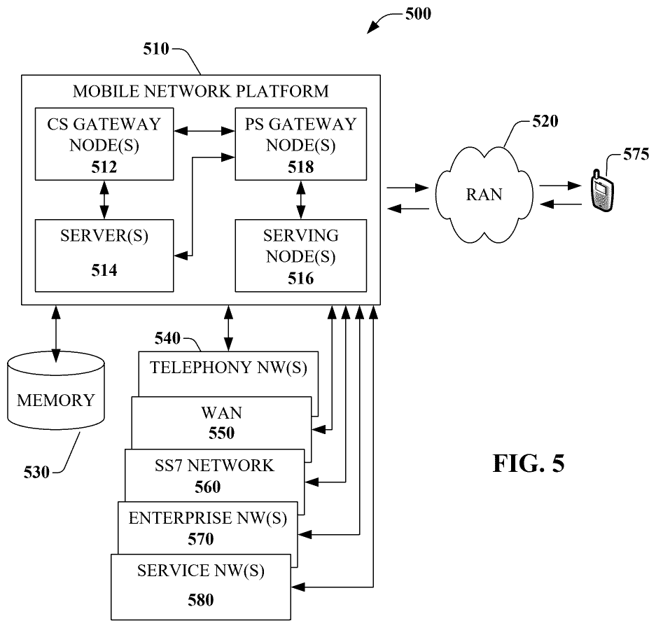

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part implementing a control plane and a user plane for managing operation of a mobile communication network; and implementing, by the processing system, an artificial intelligence/machine learning plane within the communication network that utilizes a logical channel for carrying AI/ML-related data, wherein the logical channel is mapped to a transport channel and a physical channel. Various configuration parameters can be utilized and provisioned for features of the AMP including the logical channel or the AMRB.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

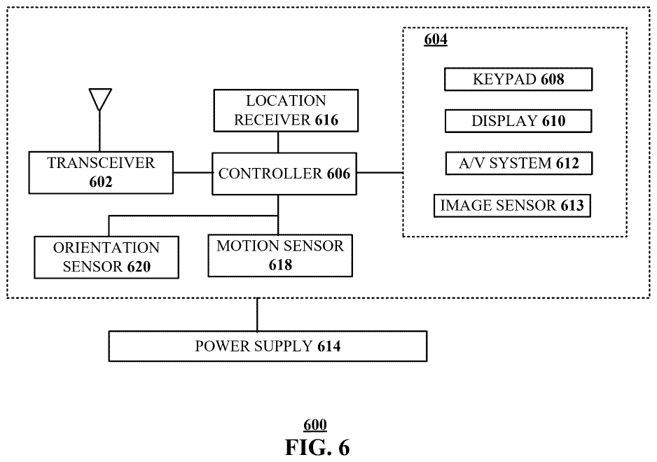

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part implementing a control plane and a user plane for managing operation of a mobile communication network; and implementing, by the processing system, an artificial intelligence/machine learning plane within the communication network that utilizes a logical channel for carrying AI/ML-related data, wherein the logical channel is mapped to a transport channel and a physical channel. Various configuration parameters can be utilized and provisioned for features of the AMP including the logical channel or the AMRB.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
establishing, by a processing system including a processor, a Packet Data Convergence Protocol (PDCP) entity for an AI/ML radio bearer (AMRB) of a communication network to manage transmission of AI/ML-related data, wherein the communication network includes a control plane, a user plane, and an artificial intelligence/machine learning plane (AMP), wherein the AMP operates independently of and in parallel with the control plane and the user plane, and wherein the AMP utilizes a logical channel for carrying the AI/ML-related data within the communication network;
configuring, by the processing system, a security for the AMRB; and
establishing, by the processing system, an AI/ML Application Protocol (AMAP) entity to interface between the AMP and other layers of the communication network.

2. The method of claim 1, wherein the establishing of the PDCP entity includes at least one of initializing a PDCP context, assigning a unique identifier to the AMRB, configuring header compression and decompression settings to optimize data transmission, or a combination thereof.

3. The method of claim 1, wherein the configuring of the security for the AMRB includes at least one of selecting an encryption algorithm, generating encryption keys, applying integrity protection mechanisms, setting up authentication protocols for communicating the AI/ML-related data, or a combination thereof.

4. The method of claim 1, wherein the establishing the AMAP entity includes at least one of defining AMAP interface parameters, linking the AMAP entity with the PDCP entity, configuring the AMAP entity to manage AI/ML data flow and control signaling across the communication network, or a combination thereof.

5. The method of claim 1, further comprising transmitting, by a base station of the communication network to a communication device, a Radio Resource Control (RRC) message that includes configuration parameters for the logical channel, wherein the logical channel comprises an uplink logical channel and a downlink logical channel; and
receiving, by the base station from the communication device, the AI/ML-related data via the uplink logical channel.

6. The method of claim 5, wherein the configuration parameters include at least one of a priority level, a bucket size duration, and a logical channel group.

7. The method of claim 1, wherein the AMAP entity is configured to manage AI/ML data traffic on the logical channel by dynamically adjusting data flow parameters based on network conditions and AI/ML model parameters.

8. The method of claim 1, wherein the AMAP entity is configured to utilize a feedback mechanism to receive performance metrics from one or more AI/ML models and adjust control signaling based on the performance metrics.

9. The method of claim 1, comprising:
releasing, by the processing system, the PDCP entity and the AMRB; and
notifying, the AMAP entity, of the releasing of the AMRB.

10. The method of claim 1, wherein a Media Access Control (MAC) layer is configured to perform multiplexing and demultiplexing of the AI/ML-related data based on a priority of the AI/ML-related data.

11. A device, comprising:
a processing system including a processor; and
a memory that stores executable instructions that, when executed by the processing system, facilitate performance of operations, the operations comprising:
transmitting, by a base station of a communication network to a communication device, a message that includes configuration parameters for a logical channel for carrying AI/ML-related data within the communication network, the communication network including a control plane, a user plane, and an artificial intelligence/machine learning plane (AMP), wherein the AMP operates independently of and in parallel with the control plane and the user plane; and
receiving, by the base station from the communication device, AI/ML-related data via the logical channel.

12. The device of claim 11, wherein the message is a Radio Resource Control (RRC) message, and wherein the AI/ML-related data includes at least one of status updates on AI/ML data processing, requests for additional resources, or a combination thereof.

13. The device of claim 11, wherein the logical channel comprises a downlink logical channel and wherein the operations further comprise:
transmitting, by the base station to the communication device, other AI/ML-related data via the downlink logical channel.

14. The device of claim 11, wherein the configuration parameters include at least one of a priority level, a bucket size duration, and a logical channel group, and wherein the communication device is one of a mobile phone, a laptop computer, a wearable device, a vehicle computing system, or an IoT device.

15. The device of claim 11, wherein the operations further comprise:
managing AI/ML data traffic on the logical channel by dynamically adjusting the configuration parameters based on network conditions and AI/ML model parameters.

16. The device of claim 11, wherein a Media Access Control (MAC) layer is configured to perform multiplexing and demultiplexing of the AI/ML-related data based on a priority of the AI/ML-related data.

17. The device of claim 11, wherein an AI/ML Application Protocol (AMAP) entity is configured to manage AI/ML data traffic on the logical channel by dynamically adjusting data flow parameters based on network conditions and AI/ML model parameters, and wherein the AMAP entity interfaces between the AMP and other layers of the communication network.

18. A non-transitory machine-readable medium, comprising executable instructions that, when executed by a processing system including a processor, facilitate performance of operations, the operations comprising:
transmitting, by a base station of a communication network to a communication device, a message, wherein the message indicates one or more AI/ML Radio Bearers (AMRBs) to be added or modified and configuration parameters for the AMRBs, wherein the communication network including a control plane, a user plane, and an artificial intelligence/machine learning plane (AMP), wherein the AMP operates independently of and in parallel with the control plane and the user plane, and wherein a logical channel of the AMP is configured carrying AI/ML-related data within the communication network; and
receiving, by the base station from the communication device, AI/ML-related data via the logical channel.

19. The non-transitory machine-readable medium of claim 18, wherein the message is a Radio Resource Control (RRC) message, and wherein the configuration parameters for the AMRBs include security settings and Quality of Service (QoS) requirements.

20. The non-transitory machine-readable medium of claim 18, wherein a Media Access Control (MAC) layer is configured to perform multiplexing and demultiplexing of the AI/ML-related data based on a priority of the AI/ML-related data, wherein an AI/ML Application Protocol (AMAP) entity is configured to manage AI/ML data traffic on the logical channel by dynamically adjusting data flow parameters based on network conditions and AI/ML model parameters, and wherein the AMAP entity interfaces between the AMP and other layers of the communication network.
